(19) United States
(12) Patent Application Publication
(10) Pub. No.: US 2019/0096017 A1
(43) Pub. Date: Mar. 28, 2019

(54) MEDICAL PROCEDURE COST EVALUATION AND OPTIMIZATION

(71) Applicant: General Electric Company, Schenectady, NY (US)

(72) Inventors: Garry Whitley, Clinton, IL (US); Kendra Cameron, Knoxville, TN (US); Travis Frosch, Orlando, FL (US); Corey Coatney, Miamisburg, OH (US)

(21) Appl. No.: 15/714,911

(22) Filed: Sep. 25, 2017

(51) Int. Cl. G06Q 50/22; G06Q 10/06

(52) U.S. Cl. CPC G06Q 50/22; G06Q 10/06316; G06Q 10/06395

(57) ABSTRACT

Techniques are provided for evaluating and optimizing costs associated with medical procedures. In one embodiment, a system comprises an importer component that extracts historical performance information from one or more healthcare information systems regarding past performance of a medical procedure by clinicians, and an indexing component that indexes the historical performance information as a function of costs associated with the past performance of the medical procedure by respective clinicians of the clinicians. The system further comprises an analysis component that compares the historical performance information for the respective clinicians to identify a subset of the clinicians associated with one or more variances in the costs, and a workflow optimization component that facilitates determining, based on the one or more variances, a change to a workflow, employed by one or more clinicians of the subset of clinicians to perform the medical procedure, that reduces a total cost of the medical procedure.

### TECHNICAL FIELD

The present disclosure is directed to healthcare information technology systems, and in particularly to methods and systems for evaluating and optimizing costs associated with medical procedures.

### BACKGROUND

The transition from volume-driven to value-driven healthcare is transforming how patient care is delivered and paid for in the U.S. With increased pressure to improve both the quality and cost-effectiveness of care delivery, healthcare organizations need new tools that will enable them to stay profitable in the face of the transforming market landscape. However, accurate cost measurement and optimization in health care is challenging due to the complexity of health care delivery. For example, a patient's treatment can involve various types of medical procedures including propaedeutic, diagnostic, therapeutic, and surgical procedures, among others. These various types of medical procedures involve many different types of resources that have different impacts on cost, including personnel, equipment, space, and supplies. Facing major capital and operational budget pressures, healthcare organizations are seeking more effective ways to evaluate and reduce procedure costs while preserving or even enhancing patient safety, operational efficiency, and staff productivity.

### SUMMARY

The following presents a summary to provide a basic understanding of one or more embodiments of the invention. This summary is not intended to identify key or critical elements, or delineate any scope of the particular embodiments or any scope of the claims. Its sole purpose is to present concepts in a simplified form as a prelude to the more detailed description that is presented later. In one or more embodiments described herein, systems, computer-implemented methods, apparatus and/or computer program products that facilitate evaluating and optimizing costs associated with medical procedures.

In one embodiment, a system is provided that comprises a memory that stores computer executable components, and a processor that executes computer executable components stored in the memory. The computer executable components can comprise a an importer component that extracts historical performance information from one or more healthcare information systems regarding past performance of a medical procedure by clinicians, and an indexing component that indexes the historical performance information as a function of costs associated with the past performance of the medical procedure by respective clinicians of the clinicians. The computer executable components can further comprise an analysis component that compares the historical performance information for the respective clinicians to identify a subset of the clinicians associated with one or more variances in the costs, and a workflow optimization component that facilitates determining, based on the one or more variances, a change to a workflow, employed by one or more clinicians of the subset of clinicians to perform the medical procedure, that reduces a total cost of the medical procedure.

In some implementations, the computer executable components can further comprise a workflow update component that updates a workflow data file for the one or more clinicians to account for the change, wherein the workflow data file controls how the one or more clinicians are authorized to perform the medical procedure in the future. The analysis component can also further compare the historical performance information for the subset of clinicians to determine one or more procedural components associated with the past performance of the medical procedure by the subset of the clinicians that are attributed to the one or more variances, and wherein the workflow optimization component further facilitates determining the change based on the one or more procedural components. In one implementation, the change comprises a change to a medical supply employed for the medical procedure and the computer executable components can further comprise an inventory component that orders the medical supply for the future performance of the medical procedure based on the workflow data file.

In other implementations, the computer executable components can further comprise a recommendation component that provides a recommendation to update the workflow regarding the change, and an interface component that provides a graphical user interface that presents the recommendation. With these implementations, the graphical user interface can provide a workflow update function that facilitates receiving input regarding implementation of the change, and the computer executable components can further comprise a workflow update component that updates, based on the input requesting implementation of the change, a workflow data file for the one or more clinicians to account for the change, wherein the workflow data file controls how the one or more clinicians are authorized to perform the medical procedure in the future.

In another embodiment, a method is provided the comprises using a processor to execute the following computer executable instructions stored in a memory to perform the following acts: extracting historical performance information from one or more healthcare information systems regarding past performance of a medical procedure by clinicians;

indexing the historical performance information as a function of costs associated with the past performance of the medical procedure by respective clinicians of the clinicians comparing the historical performance information for the respective clinicians to identify a subset of the clinicians associated with one or more variances in the costs; and determining, based on the one or more variances, a change to a workflow, employed by one or more clinicians of the subset of clinicians to perform the medical procedure, that reduces a total cost of the medical procedure.

In another embodiment, a tangible computer-readable storage medium is provided that comprises computer-readable instructions that, in response to execution, cause a computing system to perform operations. These operation can include

presenting cost information via a graphical user interface regarding one or more variances in costs associated with a medical procedure performed by clinicians, wherein the graphical user interface facilitates identifying and changing one or more procedural components associated with medical procedure that are attributed to the one or more variances in the costs. These operations can further include presenting, via the graphical user interface, a workflow data file for a clinician of the clinicians based on reception of first input selecting the clinician based on the cost information and requesting updating of the workflow data file, wherein the workflow data file controls future performance of the medical procedure by the clinician, and updating the workflow data file based on reception of second input requesting a change to a parameter included in the workflow data file.

### BRIEF DESCRIPTION OF THE DRAWINGS

Numerous aspects, embodiments, objects and advantages of the disclosed subject matter will be apparent upon consideration of the following detailed description, taken in conjunction with the accompanying drawings, in which like reference characters refer to like parts throughout, and in which:

FIG. 1 illustrates an example system for evaluating and optimizing costs associated with medical procedures in accordance with various aspects and embodiments described herein.

FIG. 2 provides an example data model that can be employed by the to organize or arrange different types of information associated with evaluating procedure costs in accordance with various aspects and embodiments described herein.

FIG. 3 provides an example healthcare IT server that facilitates evaluating and optimizing costs associated with medical procedures in accordance with various aspects and embodiments described herein.

FIGS. 4-9 provide example graphical user interfaces and visualizations provided by a procedure evaluation application that facilitates evaluating and optimizing costs associated with medical procedures in accordance with various aspects and embodiments described herein.

FIG. 10 provides another example healthcare IT server that facilitates evaluating and optimizing costs associated with medical procedures in accordance with various aspects and embodiments described herein.

FIGS. 11-17 provide example graphical user interfaces and visualizations provided by a workflow information evaluation application that facilitates evaluating and optimizing costs associated with medical procedures in accordance with various aspects and embodiments described herein.

FIG. 18 provides another example healthcare IT server that facilitates evaluating and optimizing costs associated with medical procedures in accordance with various aspects and embodiments described herein.

FIG. 19 is a flow diagram of an example method for evaluating and optimizing costs associated with medical procedures in accordance with various aspects and embodiments described herein.

FIG. 20 is a flow diagram of another example method for evaluating and optimizing costs associated with medical procedures in accordance with various aspects and embodiments described herein.

FIG. 21 is a flow diagram of another example method for evaluating and optimizing costs associated with medical procedures in accordance with various aspects and embodiments described herein.

FIG. 22 is a schematic block diagram illustrating a suitable operating environment in accordance with various aspects and embodiments.

FIG. 23 is a schematic block diagram of a sample-computing environment in accordance with various aspects and embodiments.

### DETAILED DESCRIPTION

The following detailed description is merely illustrative and is not intended to limit embodiments and/or application or uses of embodiments. Furthermore, there is no intention to be bound by any expressed or implied information presented in the preceding Background or Summary sections, or in the Detailed Description section.

By way of introduction, the subject matter described in this disclosure provides techniques for evaluating and optimizing costs associated with medical procedures. The disclosed techniques provide solutions that harness the power of integrated clinical and financial data to evaluate costs associated with resources used for various types of medical procedures and determine mechanism to improve financial performance. In one or more embodiments, the disclosed techniques provide for retrieving and evaluating historical information regarding procedure costs attributed to resources used in various medical procedures by different clinicians. Using machine learning, the historical data can be analyzed at various levels to identify procedural factors/components associated financial loss and gain. For example, procedure costs can be analyzed with respect to various key performance indicators (KPIs), ranging from cost by service, procedure, clinician average cost by resource type, inventory procedure cost by resource type, and beyond. Based on this analysis, variations attributed to financial loss and gain in the processes, tools, equipment, and materials used by different clinicians performing the same procedure can be identified. By providing insights on cost of each procedure, performed by individual clinicians, synced with inventory usage and vendor preference, the disclosed techniques can further help to decrease procedure costs and variability.

In one or more embodiments, the disclosed techniques involve analyzing the historical performance data to automatically identify variances in costs associated with same procedures performed by different clinicians. Root cause analysis can further be performed to automatically identify individual procedural components (e.g., specific resources and parameters of the resources) attributed to the variances. Based on the identified components and machine learning analysis of the historical data, mechanisms can further be automatically determine or infer mechanisms to reduce or eliminate the variances and improve cost while maintaining clinical quality and efficacy standards. These mechanisms can further be recommended to healthcare professionals for future implementation, and in some implementation automatically integrated into future workflows. For example, changes to supplies ordered and utilized, staffing, room/space utilization, scheduling and the like can be automatically updated in electronic based systems that respectively mange supply ordering/utilization, staffing, room/space utilization, scheduling, and various other workflow management systems.

The disclosed techniques also provide software applications that facilitate evaluating procedural costs by users in an efficient and effective way, thereby allowing users to make informed decision regarding implementing procedural changes to improve costs. In one embodiment, a procedure evaluation application is described that facilitates quickly generating actionable insights by creating customized dashboards of performance metrics in solution-driven workflows. The procedure evaluation application can allow users to track different KPIs reflective of various procedure costs to drill down and uncover individual procedural components where financial improvement can be achieved. As a result, customers will be able to readily extract insights from their data, utilizing performance dashboards created in a rapid and customizable fashion.

In addition to providing actionable insights regarding procedural changes that can be made to improve costs, the disclosed subject matter provides mechanisms for implementing these changes in future workflows. In particular, in one or more additional embodiments, a workflow information evaluation application is described that allows users to view workflow information that defines how a particular medical procedure should be performed. For example, the workflow information can identify resources to be used, how they are to be used, procedural steps to be performed, how the procedural steps are to be performed, and the like. In some implementations, the workflow information can control how a particular clinician is authorized to perform a particular procedure, including what medical supplies the clinician is authorized to order and use. In addition to viewing the workflow information, the workflow information application can further provide for making changes to the workflow information that optimize costs. The updated workflow information can further be integrated into the clinical environment to control future workflows. The particular workflow information for updating and the particular changes to be made can be determined and recommended based on automated analysis of the historical data and/or user analysis of the historical data facilitated by the procedure evaluation application.

As used herein, a medical procedure is a course of action intended to achieve a result in the delivery of healthcare. Various embodiments of the subject disclosure are exemplified with reference to analysis of costs associated with medical supplies/instruments used in surgical procedures. However, it should be appreciated that the disclosed subject matter is not limited to evaluating only medical supplies/instruments used in association with surgical procedures. In particular, the disclosed subject matter can be employed to analyze and identify variances in procedural costs attributed to a variety of other factors, including but not limited to, other types of resources used (e.g., personnel, space, equipment), number of procedures performed, infection rate, length of stay (LOS), reimbursement, and the like. Further, in addition to surgical procedures the disclosed techniques can be employed to evaluate various other types of medical procedures, including propaedeutic, diagnostic, therapeutic, and imaging, among others. The term clinician is used herein to refer to any entity that performs a healthcare related procedure or action. The type of the healthcare related procedure or action can vary. For example, a clinician can include but is not limited to: a physician, a nurse, a physician's assistant, a therapist, a medical technician, a midwife and the like.

The innovation is described with reference to the drawings, wherein like reference numerals are used to refer to like elements throughout. In the following description, for purposes of explanation, numerous specific details are set forth in order to provide a thorough understanding of this innovation. It may be evident, however, that the innovation can be practiced without these specific details. In other instances, well-known structures and components are shown in block diagram form in order to facilitate describing the innovation.

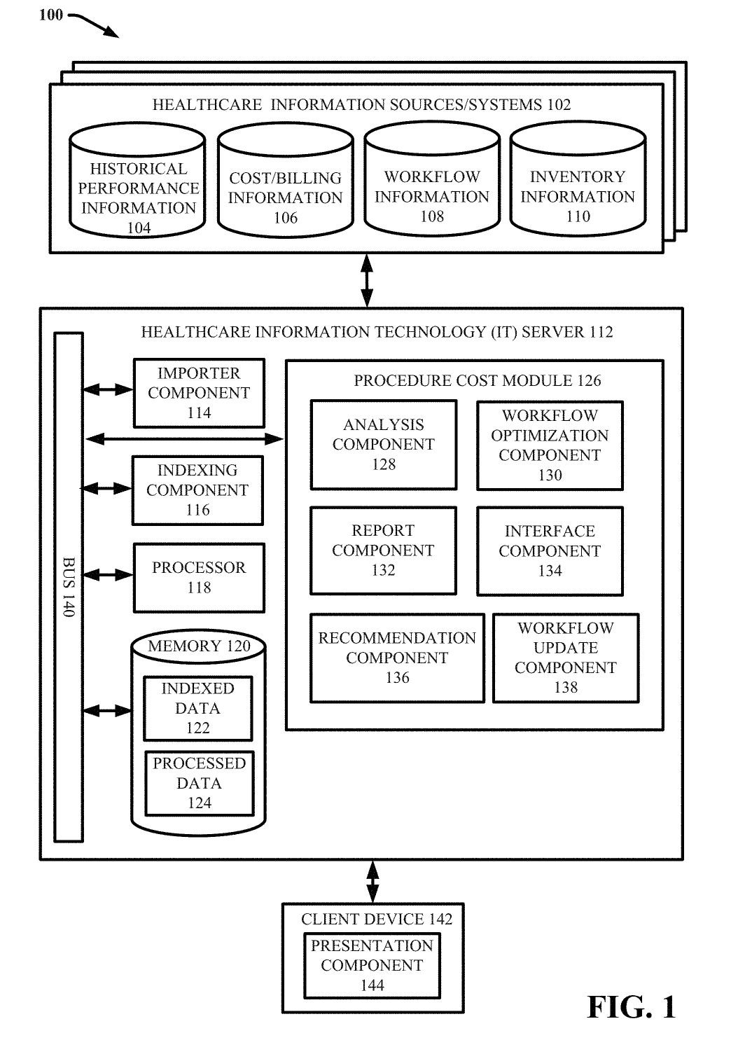

Referring now to the drawings, with reference initially to FIG. 1, presented is diagram of an example system 100 that facilitates evaluating and optimizing costs associated with medical procedures in accordance with various aspects and embodiments described herein. Aspects of systems, apparatuses or processes explained in this disclosure can constitute machine-executable components embodied within machine(s), e.g., embodied in one or more computer readable mediums (or media) associated with one or more machines. Such components, when executed by the one or more machines, e.g., computer(s), computing device(s), virtual machine(s), etc. can cause the machine(s) to perform the operations described.

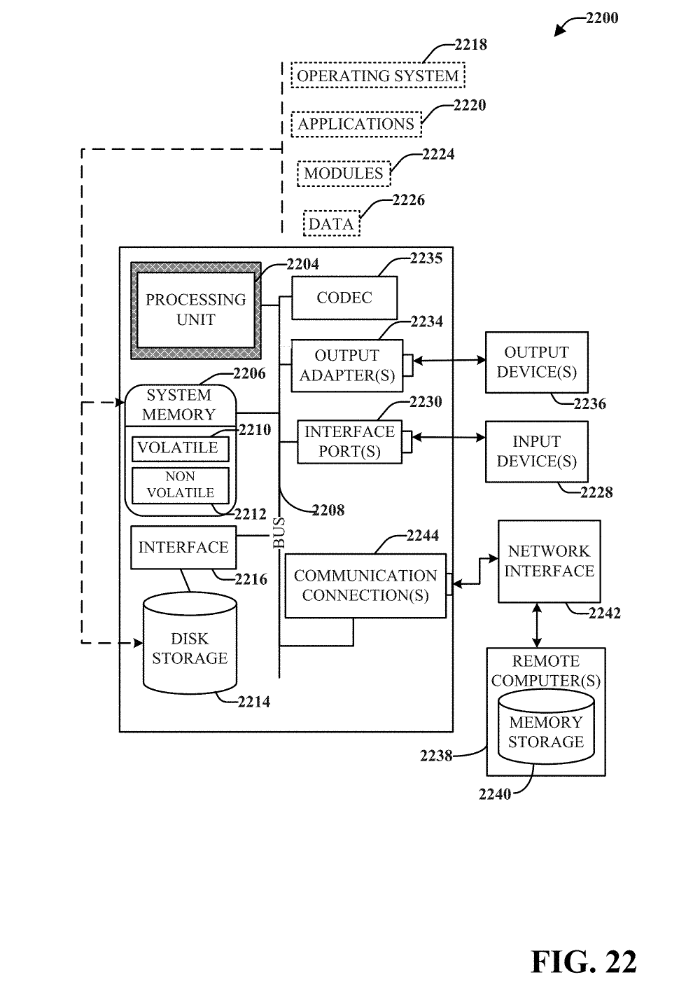

System 100 includes healthcare IT server 112, one or more healthcare information sources/systems 102, and a client device 142. Generally, the healthcare IT server 112, the one or more healthcare information sources/systems 102 and the client device 142 can include memory that stores computer executable components and a processor that executes the computer executable components stored in the memory, examples of which can be found with reference to FIG. 22. For example, in the embodiment shown, the healthcare IT server 112 can include or be communicatively coupled to at least one memory 120 that stores computer executable components. These computer executable components can include for example, importer component 114, indexing component 116, and procedure cost module 126. The healthcare IT server 112 can include processor 118 to execute these computer executable components. The healthcare IT server 112 can further include a system bus 140 to communicative couple the various components of the healthcare IT server 112 (e.g., the importer component 114, the indexing component 116, the processor 118, the memory 120, and the procedure cost module 126.

The healthcare IT server 112 can provide centralized information processing for integrated healthcare organizations or environments to create actionable insight across the healthcare system and the care pathway, enabling better clinical and financial outcomes. In accordance with the disclosed subject matter, the healthcare IT server 112 can be particularly configured to provide tools that facilitate evaluating and optimizing costs associated with medical procedures based on analysis of various types of information accessible to the healthcare IT server 112 at one or more healthcare information sources/systems 102. These healthcare information sources/systems 102 can include any potential information source or system that can provide and/or employ insight regarding all facets of operation and performance of the healthcare organization, from the patients and healthcare personnel to physical tools and structures associated with the integrated healthcare organization. For example, the one or more healthcare information sources/systems 102 can include billing systems, electronic medical record (EMR) system, scheduling systems, patient monitoring systems, workflow management systems, real-time procedure optimization systems, inventory management systems, and the like. In accordance with facilitating procedure cost evaluation and optimization, the one or more healthcare information sources/systems 102 can provide information including but not limited to, historical performance information 104, cost/billing information 106, workflow information 108 and inventory information 110.

The components of healthcare IT server 112 can be provided at one or more dedicated computing devices (e.g., real or virtual machines). Users can interface with healthcare IT server 112 using a client device 142. As used in this disclosure, the terms “user,” “healthcare professional,” “clinician,” “employee,” “administrator” and the like refer to a person, entity, system, or combination thereof that can employ system 100 (or additional systems described in this disclosure) using a client device 142. The client device 142 can include any suitable computing device associated with a user and configured to interact with healthcare IT server 112 and/or one or more healthcare information sources/systems 102. For example, client device 142 can include a desktop computer, a laptop computer, a television, an Internet enabled television, a mobile phone, a smartphone, a tablet personal computer (PC), or a personal digital assistant PDA. In an aspect, the client device 142 can include presentation component 144 to generate and/or display a graphical user interface (GUI) configured by healthcare IT server 112 that facilitates viewing and interacting with information generated by healthcare management server and interacting with healthcare management server to access and develop reports based on processing capabilities of healthcare IT server 112.

In one or more embodiments, the healthcare IT server 112 can provide various services to user via a suitable network accessible platform. For example, in some implementations, presentation component 144 can include an application (e.g., a web browser) for retrieving, presenting and traversing information resources on the World Wide Web. According to this aspect, healthcare IT server 112 can provide processed information and interactive procedure cost evaluation and optimization tools to users via a website platform that can be accessed using a browser provided on their respective client devices (e.g., client device 142). In another implementation, the healthcare IT server 112 can provide processed information and interactive procedure cost evaluation and optimization tools to users via a mobile application, a thin client application, a thick client application, a hybrid application, a web-application and the like. Still in other implementations, one or more components of the healthcare IT server 112 can be provided at the client device 142 and accessed directly in an offline mode.

The various components and devices of system 100 can be connected either directly or via one or more networks, (not shown). Such network(s) can include wired and wireless networks, including but not limited to, a cellular network, a wide area network (WAD, e.g., the Internet), a local area network (LAN), or a personal area network (PAN). For example, a client device 142 can communicate with the healthcare IT server 112, one or more healthcare information sources/systems 102 and/or another client device (and vice versa) using virtually any desired wired or wireless technology, including, for example, cellular, WAN, wireless fidelity (Wi-Fi), Wi-Max, WLAN, and etc. In an aspect, one or more components of system 100 are configured to interact via disparate networks. It is to be appreciated that although various components of healthcare IT server 112 are depicted as co-located on a same device, such implementation is not so limited. For example, one or more components of healthcare IT server 112 can be located at another device or associated system, a client device 142 another server, and/or the cloud.

In the embodiment shown, the healthcare IT server 112 can include importer component 114, indexing component 116, and procedure cost module 126. The importer component 114 can be configured to import, extract, receive or otherwise access the information provided at the one or more healthcare information sources/systems 102 for processing by the procedure cost module 126. This information can include but is not limited to, historical performance information 104, cost/billing information 106, workflow information 108 and inventory information 110.

The historical performance information 104 can include information regarding past procedures performed by clinicians associated with one or more healthcare organizations. Such historical performance information can include but is not limited to, information identifying clinicians and the procedures they have performed in the past (e.g., including information describing a type of the procedure, a procedure code, and the like), information regarding timing of performance of past procedures (e.g., including date of the procedure, duration of the procedure, etc.), and information regarding patient clinical outcomes associated with past procedures. For each procedure (or in some implementations, one or more), the historical performance information 104 can also include detailed information regarding resources used in association with performance of the respective procedures, including but not limited to, medical supplies used, medical equipment used, personnel involved in the procedure, room/space usage, and the like. In some embodiments, the historical performance information can also identify workflows flowed for the procedure, including processes performed, timing of the processes performed, order of the processes performed, results or outcomes of the processes performed, etc.

The cost/billing information 106 can include any type of financial information pertaining to costs associated with past, current, or future medical procedures. For example, with respect to past procedures, the cost/billing information 106 can identify total costs (e.g., to the healthcare organization) of each procedure performed, as well as line item costs associated with individual components of the procedures, including supplies/equipment costs, personnel costs, room/space costs, individual process or procedural steps, and the like. In some implementations, the cost/billing information can also include information regarding reimbursement for respective procedures, including total reimbursement and reimbursement for procedural components. In some implementations, the cost/billing information 106 can also include cost information attributed to LOS, and procedure complications.

The workflow information 108 can include information defining workflows for various procedures. In this regard, the workflow information can identify or define one or more standardized protocols for following in association with performance of a procedure. For example, the workflow information can identify procedural steps or processes to be performed, timing of the steps, information regarding how each step/process should be performed, and the like. The workflow information can also define resource requirements and recommendations for respective procedures, including supplies/instruments to be utilized, equipment to be utilized, information regarding how the supplies/instruments and equipment should be utilized (e.g., authorized types of usage, authorized amounts of usage, etc.). In some embodiments, the workflow information 108 can include workflow data files for each (or one or more) clinician that includes information describing workflow preferences for performing a particular procedure. For example, in some implementations, the workflow data files can list all the necessary equipment, instruments, supplies and other appropriate resources needed for a successful procedure. The workflow data files can also include specific notes or comments that are meaningful to the clinician and other clinicians involved in the procedure to provide the best care. For example, a workflow data file for a particular surgical procedure can describe exactly which supplies to have in the operating room, when to have them available, how to prepare them and handle them, and the like. In the healthcare environments, these types of workflow data files are generally referred to as doctor preference cards (DPCs), physician preference cards (PPCs), clinician preference cards (CPCs) and the like. Various embodiments of the subject disclosure are refer to a workflow data file as a DPC. However, it should be appreciated that the term DPC does not limit the type of information that can be included in the workflow data file.

The inventory information 110 can include information regarding medical supplies, instruments, equipment and the like that are used by a healthcare organization in association with performance of medical procedures. In this regard, the inventory information can identify all medical supplies, instruments, equipment that are in stock or otherwise in possession by the medical organization, their status (e.g., used/unused, current/expired, working/broken, etc.), what they are used for, where they are located and the like. The inventory information 110 can also include records of when respective medical supplies, instruments, equipment, etc. were ordered, what they were order for (e.g., a specific procedure, a specific clinician, a specific medical department, a specific operating room, etc.), and where the supplies came from. The inventory information 110 can also include same or similar information for supplies that are out of stock, ordered, and to be ordered.

The indexing component 116 can be configured to organize or arrange received/accessed information from the one or more healthcare information sources/systems 102 according to a defined index or data model that relates various aspects of the information (e.g., in a computer readable manner). For example, the indexing component 116 can identify relationships between the data received from the one or more healthcare information sources/systems 102 and organize the data accordingly.

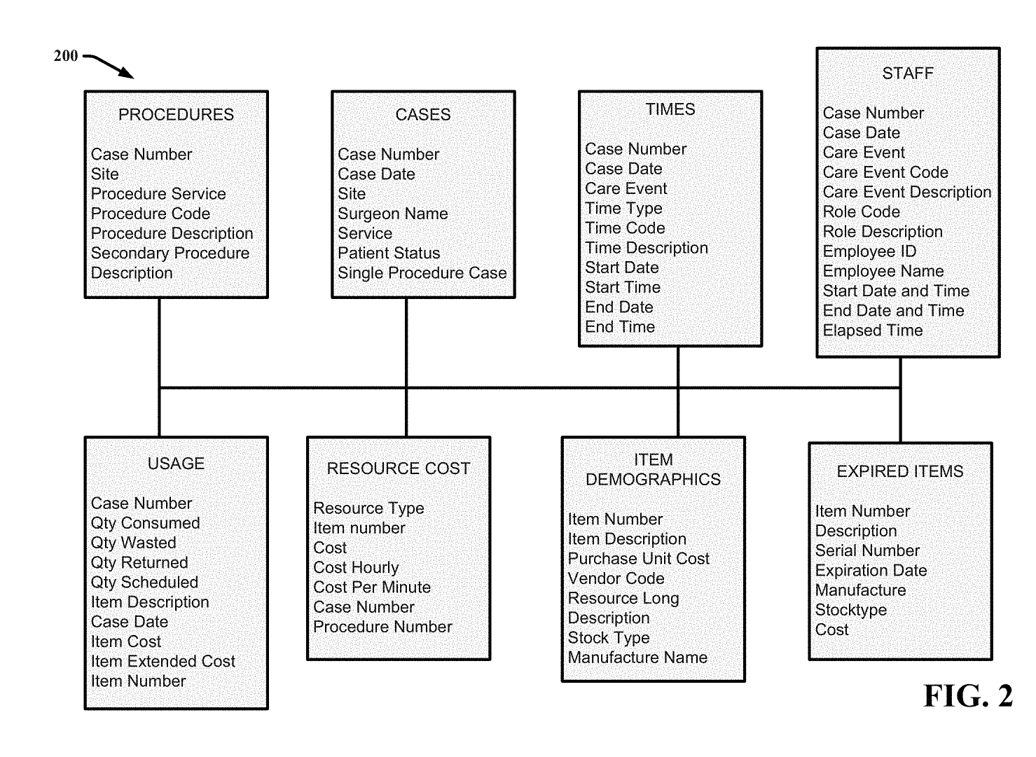

FIG. 2 provides an example data model 200 that can be employed by the indexing component 116 to organize or arrange the different types of information received by the importer component 114. In the embodiment shown, the information is organized into eight categories including, procedures, cases, times, staff, usage, resource cost, item demographics, and expired items. It should be appreciated that information arranged by the data model 200 is exemplary and that the importer component 114 can extract various additional or alternative information from the one or more healthcare information sources/systems 102.

With reference back to FIG. 1, in one embodiment, in association with facilitating analysis of the imported information by the procedure cost module 126, with respect to costs associated medical procedures performed, the indexing component 116 can index the historical performance information as a function of costs associated with the past performance of the medical procedure by respective clinicians. The indexed information can be stored at healthcare IT server 112 (e.g., as indexed data 122) or otherwise made accessible to the procedure cost module 126. The indexed data 122 can facilitate efficient comparison and analysis of procedure costs associated with an integrated healthcare organization in ways that were previously not performed because the data necessary for such analysis was distributed amongst a plurality of different healthcare information sources and was not aggregated, indexed and related. Most current healthcare analytical applications are restricted by requiring data to be examined against a limited number of predefined dimensions. The healthcare IT server 112 removes these restrictions by employing indexing component 116 to map characteristics that were historically either considered mutually exclusive (e.g., diagnosis related group (DRG) code (an institutional billing code), and current procedural terminology (CPT) code (the professional procedure code)) to a common or related baseline feature (e.g., a patient identity, a patient encounter, etc.) and then allowing comparison across multiple dimensions.

The procedure cost module 126 can be configured to employ the indexed data 122 to facilitate evaluating and optimizing procedure costs. In this regard, the procedure cost module 126 can help to decrease procedure costs and variability by providing insights on cost of each procedure performed by individual physicians, synced with inventory usage and vendor preference. In one or more embodiments, the procedure cost module 126 can include analysis component 128, workflow optimization component 130, report component 132, interface component 134, recommendation component 136 and workflow update component 138.

In one or more embodiments, the analysis component 128 can be configured to compare the historical performance information for respective clinicians and procedures to identify information regarding costs associated with the clinicians, the procedures, and respective components of the procedures. In particular, the analysis component 128 can compare historical performance information regarding various aspects of past procedures performed by clinicians and costs attributed to the respective procedures to determine areas for improving costs based on various defined metrics or KPI.

For example, the analysis component 128 can be configured to look at the indexed historical performance information, cost/billing information, workflow information, and inventory information to determine historical costs (e.g., average cost, median cost, low cost, high cost, etc.) of one or more types of procedures grouped by service and historical costs of different procedure within a particular service. The analysis component 128 can thus compare different service areas and procedures with respect to historical costs to determine how the respective services and procedures rank with respect to cost. For example, the analysis component 128 can identify relatively high, median and low costing service areas and/or procedures. The analysis component 128 can also be configured to determine historical quantities (e.g., per a defined time frame, such as per week, per month, per year, etc.) of cases for a particular type of procedure performed, including number of cases performed by individual clinicians. In this regard, the analysis component 128 can identify relative amounts of cases of a particular procedure performed by different clinicians. In some embodiments, the analysis component 128 can filter out certain clinician and cases for deeper line item evaluation based on performance of less than a threshold number of cases.

The analysis component 128 can also be configured to determine, for a particular procedure, the average costs associated with performance of the procedure by different clinicians. Thus the analysis component 128 can identify subsets of clinicians that are associated with median costs, relatively high costs and relatively low costs compared to other clinicians for the same procedure and/or defined thresholds or percentiles. For an individual clinician and a specific type of procedure performed by the clinician, the analysis component 128 can also determine costs associated with different components of the procedure, including costs associated with resources used (e.g., including supplies, equipment, staffing, room/space, time, etc.), processes or procedural steps performed, and other potential workflow factors that had an effect on the cost of the procedure. In another example, the analysis component 128 can be configured to compare procedure costs for a same procedure over time to identify trends in changes to the procedure costs over time. For example, the analysis component 128 can identify procedures or clinicians that are associated with a decrease or increase in cost over time. Thus the analysis component 128 can facilitate determining why a particular procedure cost has decreased or increased over time.

The analysis component 128 can further be configured to analyze healthcare-provider inventory, suppliers and the cost of supplies, instruments, equipment and the like, (collectively referred to herein as materials) used in various procedures. For example, materials account for a significant portion of the cost of surgery. In stock, non-stock, and special order items on hand typically run from about $1 million for smaller hospitals to around $4 million for larger institutions. Averaging about nine inventory turns a year, hospitals are spending anywhere from $6 million to $24 million annually on supplies. Management of the operating room (OR) supply chain is thus a critical step to helping reduce these costs. According, in one or more embodiments, the analysis component 128 can look at how specific resources are used in association with different procedures and/or a particular type of procedure. For example, the analysis component 128 can determine what resources are used, how often they are used or amounts of usage, when they are used, and costs associated with usage of the respective resources. The analysis component 128 can further identify costs associated with usage of the respective resources to identify high median, low and high cost resources. The analysis component 128 can also examine resources with respect to waste to identify historical trends or patterns associated with wasted resources. For example the analysis component 128 can identify resources that became expired, what procedures they are used for, what clinicians requested ordering of the expired resources, how often they expire, when the expired, if they could have been returned or used prior to expiration, and the like. Accordingly, the analysis component 128 can facilitate determining mechanisms to reduce waste associated with expired resources. The analysis component 128 can also determine information regarding cost of supplies by service, cost of supplies by procedure, returned supplies by procedure, returned supplies per clinician, and the like. With respect to supplies, the analysis component can determine trends in unused and used items to help identify items or supplies for changing the quantity kept in stock. The analysis component 128 can also determine information regarding the amount or percentage of a particular supply, instrument, etc., used per procedure, per clinician, and the like.

In some embodiments, in addition to determining the various KPIs described above, the analysis component 128 can be configured to determine variances and correspondences between the historical performance information with respect to cost. In this regard, the analysis component 128 can identify procedures, clinicians, procedural components, resources (e.g., materials, personnel, room/space, etc.), and the like, that are consistently attributed to low costs, median costs, high costs, and the like (e.g., with respect to one or more defined thresholds or benchmark). With respect to a single cost group, such a low cost for example, the analysis component 128 can identify correspondences between aspects of the procedure that are consistently attributed to the low cost. Likewise, the analysis component 128 can identify correspondences between aspects of the procedure that are consistently attributed to the high cost. The analysis component 128 can also identify procedures, clinicians, procedural components, and the like that are associated with cost variances. For example, the analysis component 128 can identify significant variation in the processes, tools, equipment, and materials used by physicians performing the same service within the same unit in the same facility. For instance, in total knee replacement, surgeons often use different implants, surgical kits, surgeons' hoods, and supplies, thereby introducing substantial cost variation in treating patients with the same condition at the same site.

In one embodiment, the analysis component 128 can compare different cases or clinicians involving performance of a same procedure to identify a subset of the cases or clinicians that are associated with substantial cost variances (e.g., with respect to a defined difference percentage or degree of deviation). For instance, the analysis component 128 can identify a subset of cases or clinicians including a first group associated with relatively high costs and a second group associated with relatively low costs. The analysis component 128 can further perform root cause analysis to identify specific procedural components (e.g., resources used, processes performed, workflows followed, etc.), that are attributed to the cost variances. In this regard, the analysis component 128 can identify correspondences between aspects of the procedure (e.g., regarding the specific clinician that performs the procedure, the timing of the performance of the procedure, the location, the staff involved, the resources used, the workflow followed, etc.) that are consistently attributed to the low costs and high costs. For example, the analysis component 128 can compare the low cost group with the high cost group to identify consistent differences between one or more procedural components between the two groups that have a substantial impact on cost (e.g., with respect to a defined threshold). For instance, with respect to a surgical procedure, the analysis component 128 could determine that a particular clinician or group of clinicians use a particularly high cost implant for which there is a low cost alternative being used by the low cost group.

In another example implementation, the analysis component 128 can identify discrepancies between quantity of cases performed for a particular procedure by a particular clinician and the collective or total costs of all the cases. For example, the analysis component 128 can determine that two clinicians are associated with similar total costs for a defined time period (e.g., one month, one week, one year, etc.) for a particular procedure, yet one of the clinicians performed significantly fewer cases (e.g., with respect to a defined threshold value) relative to the other. The analysis component 128 can further determine why the later clinician is associated with significantly higher costs per case. For example, the analysis component 128 can determine if the higher costs are attributed to a variable that can be changed or optimized (e.g., with respect to resource utilization), or not (e.g., cost of the clinician due to the clinician having a higher pay grade).

In one or more embodiments, the workflow optimization component 130 can be configured to analyze the cost variances and/or reasons for the cost variances determined by the analysis component 128 to determine one or more mechanism to converge on an optimal workflow for respective procedures. In this regard, the workflow optimization component 130 can determine if changes can be made to one or more aspects of a procedural workflow with respect to resources used, processes performed, and who they are performed by, etc. to reduce the total cost associated with performance of the procedure in the future, and what those changes are. In this regard, the workflow optimization component 130 can identify areas where costs savings can be realized without impacting (and potentially improving), the clinical efficacy and efficiency of the procedure. For example, in some implementations, the workflow optimization component 130 can be configured identify unnecessary (e.g., from a clinical standpoint), and/or wasteful resource utilization and determine how to change what resources are used for respective procedures, when they are used, how they are used, who they are used by and the like, to save costs. For example, the workflow optimization component 130 can identify opportunities to convert a surgeon to a clinically equivalent, lower-cost supply that his colleagues use to achieve similar outcomes. In another example, the workflow optimization component 130 can also identify opportunities to convert an entire group of clinicians to the same supply, enabling the healthcare organization to leverage volume purchasing as well as standardize products and reduce inventory variability. The workflow optimization component 130 can also determine the amount of savings that could be realized if the changes were implemented.

In various embodiments, the analysis component 128 and the workflow optimization component 130 can employ one or more machine learning techniques to facilitate evaluation and optimization of procedural costs. In particular, the analysis component 128 can employ one or more machine learning techniques to identifying correspondences and variances between costs associated with different clinicians, procedures and procedural components. The analysis component 128 can also employ one or more machine learning techniques to determine specific aspect of procedural workflows (e.g., resources utilized, how they are utilized, processes performed, and the like), that are attributed to financial gains and losses. The workflow optimization component 130 can also employ one or more machine learning techniques to determine workflow modifications that can be implemented to reduce procedural costs and improve efficiency, thereby converging on optimal workflows for different procedures and/or different clinicians.

Machine learning is a type of artificial intelligence (AI) that provides computers with the ability to learn without being explicitly programmed. In order to provide for or aid in the numerous inferences described herein, the analysis component 128 and the workflow optimization component 130 can examine the entirety or a subset of the data to which it is granted access and can provide for reasoning about or infer states of the system (e.g., system 100 and the like), environment, etc. from a set of observations as captured via events and/or data. An inference can be employed to identify a specific context or action, or can generate a probability distribution over states, for example. The inference can be probabilistic (e.g., the computation of a probability distribution over states of interest can be based on a consideration of data and events). An inference can also refer to techniques employed for composing higher-level events from a set of events and/or data. Such an inference can result in the construction of new events or actions from a set of observed events and/or stored event data, whether or not the events are correlated in close temporal proximity, and whether the events and data come from one or several event and data sources. Various classification (explicitly and/or implicitly trained) schemes and/or systems (e.g., support vector machines, neural networks, expert systems, Bayesian belief networks, fuzzy logic, data fusion engines, etc.) can be employed in connection with performing automatic and/or inferred action in connection with the claimed subject matter.

A classifier can map an input attribute vector, x=(x1, x2, x4, x4, xn), to a confidence that the input belongs to a class, such as by f(x)=confidence(class). Such classification can employ a probabilistic and/or statistical-based analysis (e.g., factoring into the analysis utilities and costs) to prognose or infer an action that a user desires to be automatically performed. A support vector machine (SVM) is an example of a classifier that can be employed. The SVM operates by finding a hyper-surface in the space of possible inputs, where the hyper-surface attempts to split the triggering criteria from the non-triggering events. Intuitively, this makes the classification correct for testing data that is near, but not identical to training data. Other directed and undirected model classification approaches include, e.g., naïve Bayes, Bayesian networks, decision trees, neural networks, fuzzy logic models, and probabilistic classification models providing different patterns of independence can be employed. Classification as used herein also is inclusive of statistical regression that is utilized to develop models of priority.

In some embodiments, the information determined by the analysis component 128 and the workflow optimization component 130 can be stored in memory 120 (e.g., as processed data 124) and/or exported to another system or device. The procedure cost module 126 can also include report component 132 to generate reports regarding the information determined by the analysis component 128. These reports can also be stored in memory 120, exported to another system or device, and/or presented to a user at a client device 142 (e.g., using presentation component 144) in a graphical user interface generated by the interface component 134. As a result, clinical practice leaders can make more constructive and better informed discussions about how best to standardize care and treatment processes to reduce the costs of variability and limit the use of expensive approaches and materials that do not demonstrably lead to improved outcomes. For example, a report generated by the report component 132 and presented to a user can include information identifying one or more KPIs associated with a particular procedure, group of procedures, clinician, group of clinicians, resource and the like. In another example, a report can include information identifying one or more procedural components that are attributed to financial loss, financial gain with respect to a particular procedure. A report can also include information determined by the workflow optimization component 130 regarding how to modify the workflow followed for a procedure by one or more clinicians to reduce costs associated with the procedure. The reports generated by the report component 132 can include charts, graphs, tables and the like that facilitate conveying information regarding procedure cost variances and cost savings opportunities in a concise and user friendly manner.

In some embodiments, the procedure cost module 126 can include recommendation component 136 to generate and provide recommendations regarding the changes to procedure workflows determined for a particular procedure and/or clinician by the workflow optimization component 130. In this regard, the recommendation component 136 can generate and send the recommendations to the appropriate users for which a recommendation is based and/or that are authorized to act on the recommendations. For example, if the workflow optimization component 130 determines that a particular clinician should switch to using a lower cost item for a particular procedure in the future, the recommendation component 136 can generate and send the recommendation to the specific clinician using a suitable electronic messaging platform (e.g., an email, a text, a notification, etc.).

In other embodiments, the workflow update component 138 can be configured to automatically update the workflow information 108 to apply one or more changes to a workflow determined by the workflow optimization component 130. For example, in some implementations, the workflow update component 138 can make changes to workflow data files (e.g., DPCs) to reflect changes regarding resources that a clinician is authorized to employ for performance of a procedure, how the clinician is authorized to employ the recourses, and the like. In this regard, changes to the workflow information made for a particular procedure and/or clinician can control the materials that are used in the future, how the materials are used, the staff involved, the room/space used, the scheduling of procedure, timing of performance of the procedure, one or more processes performed during the procedure, and the like. In some implementations, the changes to the workflow information can control not only how a procedure is performed in the future by one or more clinicians, but what materials are ordered, when they are order, the quantities of the materials order, where the materials are stored, and the like. In some embodiments, the types of changes to the workflow information 108 that workflow update component 138 can automatically apply can be restricted. For example, the workflow update component 138 can be configured to make automatic updates to resources used yet require additional authorization prior to making changes regarding modifications to processes employed in association with a particular workflow for a procedure. In another example, the workflow update component 138 can be configured to automatically remove a supply included in DPC if the utilization is less than a defined amount. In this regard, information controlling what changes the workflow update component 138 is authorized to automatically implement and when can be defined in memory 120 or otherwise accessible to the workflow update component 138.

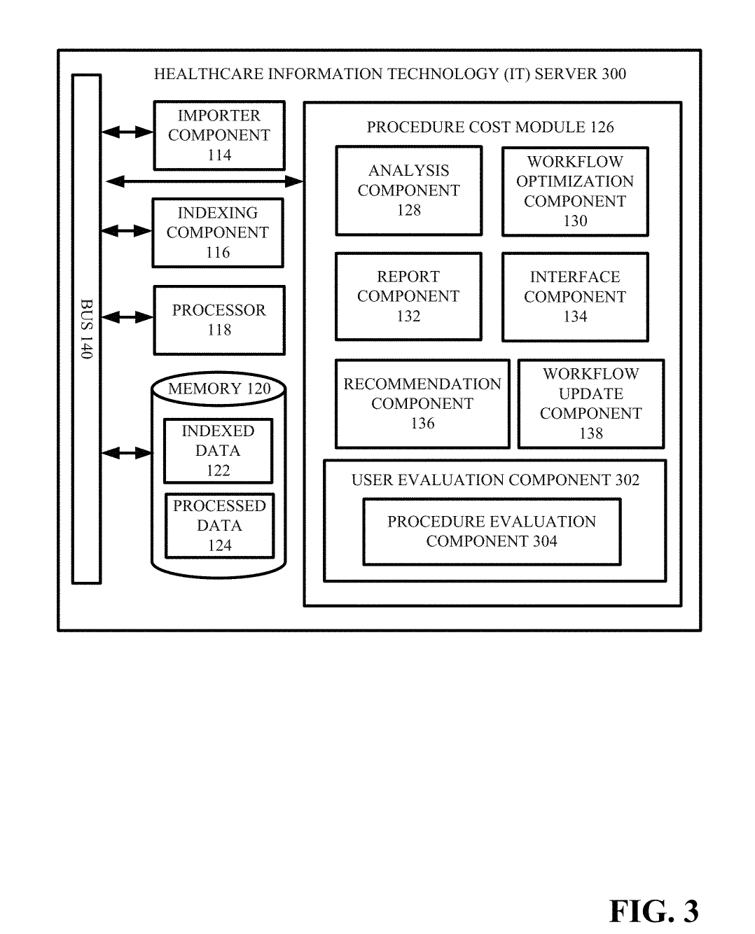

Turning now to FIG. 3, presented is another example healthcare IT server 300 that facilitates evaluating and optimizing costs associated with medical procedures in accordance with various aspects and embodiments described herein. The healthcare IT server 300 can include same or similar features and functionalities as healthcare IT server 112 with the addition of user evaluation component 302 and the procedure evaluation component 304 to the procedure cost module 126. Repetitive description of like elements employed in respective embodiments is omitted for sake of brevity.

In some embodiments, in addition to providing users with reports and recommendations regarding identified variances in procedural costs, aspects of respective procedures attributed to the variances, mechanisms for optimizing costs and minimizing or eliminating the variances, and the like, and in some implementations automatically updating workflows, the user evaluation component 302 can provide one or more interactive user applications that facilitate user investigation and evaluation of procedure costs. In this regard, the user evaluation component 302 can include procedure evaluation component 304 to facilitate guiding a user in association with uncovering cost savings opportunities in an efficient and user friendly manner. The procedure evaluation component 304 can provide facilitate generating actionable insights by creating customized dashboards of performance metrics related to procedure costs in solution-driven workflows. In particular, the procedure evaluation component 304 can provide a software application can allow users to track different KPIs reflective of various procedure costs to drill down and uncover individual procedural components where financial improvement can be achieved. As a result, customers will be able to readily extract insights from their data, utilizing performance dashboards created in a rapid and customizable fashion.

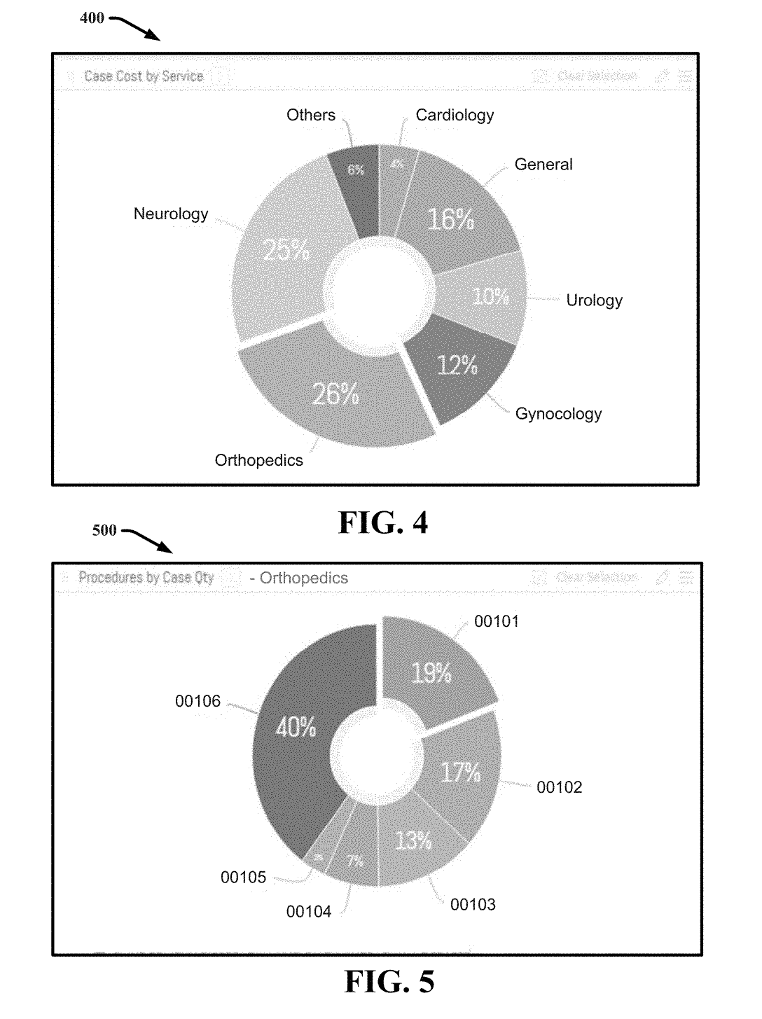

For example, in one or more embodiments, the procedure evaluation component 304 can provide a graphical user interface (e.g., generated by interface component 134) that allows users to provide input selecting criteria for processing by the analysis component 128 and/or the workflow optimization component regarding KPIs to evaluate, procedures to evaluate, clinicians to evaluate, resources to evaluate and the like. The procedure evaluation component 304 can also receive input that allows the user to control the way results are displayed, enabling the user to create customized dashboards based on a set of defined KPI or performance evaluation metrics. In particular, the procedure evaluation component 304 can provide an interactive application that allows users to view and investigate aggregated historical performance information, cost/billing information 106, workflow information 108, inventory information 110, resource utilization information and the like, and initiate generation of the various types of outputs that can be determined by the analysis component 128 and the workflow optimization component 130, as discussed infra. The particular data sets and reports generated and presented to the user will be based on user input and selection. Some of the various features and functionalities of the procedure evaluation component 304 are now described with reference to FIGS. 4-9.

FIGS. 4-9 provide example graphical user interfaces and visualizations provided by a procedure evaluation application (e.g., the procedure evaluation component 304) that facilitates evaluating and optimizing costs associated with medical procedures in accordance with various aspects and embodiments described herein. Although the various GUIs depicted in FIGS. 4-11 are shown separately, in various implementations, two or more of the visualizations included in the respective GUIs can be included in a single display or dashboard. In this regard, the different chart, tables, and visualizations can be provided in separate windows of a dashboard display in a manner that groups or relates information in the respective dashboards to one another in a user friendly display. Repetitive description of like elements employed in respective embodiments is omitted for sake of brevity.

With reference initially to FIG. 4, presented is an example GUI 400 including a pie chart that identifies average historical case costs aggregated by service type. For example, in the embodiment shown, the service types include cardiology, general, urology, gynecology, neurology, orthopedics, and others. Each of the different service types are associated with a percentage value that represents the amount of cases performed in that service area relative to all cases performed for all service areas shown. In one implementation, GUI 400 can be generated in association with initiation of the procedure evaluation application. In this regard, GUI 400 can provide an initial high level starting point from which a user can begin their investigation into more granular procedure costs information to uncover variances, correspondences and areas for financial opportunity. In another implementation, GUI 400 can be generated based on reception of user input selecting the different service types and requesting information aggregating average cases costs by service. The user input can also select the type of visualization desired (e.g., a pie chart, a table, a bar graph, etc.). In some embodiments, the information that is included in GUI 400 was preprocess or predetermined by the analysis component 128 and stored in memory 120 as processed data 124. In other implementations, the information that is included in GUI 400 can be determined by the analysis component 128 on the fly in response to initiation of the application and/or based on user input selecting one or more evaluation criteria. In accordance with some implementations, the pie chart shown in GUI 400 is selectable. For example, the different service types and/or pie chart regions can be selected to perform deeper analysis with respect to cost associated with procedures performed in the service area.

FIG. 5 presents an example GUI 500 including another pie chart that identifies percentage quantities of cases performed for different types of procedures included within a particular service type which in this implementation is orthopedics. The different types of procedures are respectively identified by procedure codes 00101, 00102, 00103, 00104, 00105, and 00106. It should be appreciated that these specific procedure codes are merely exemplary. In one embodiment, the procedure evaluation component 304 can be configured to generate GUI 500 in response to reception of user input selecting the orthopedics service type from GUI 400. For example, the user can choose to select the highest costing service, orthopedics, for deeper investigation. In some embodiments, the information that is included in GUI 500 was preprocess or predetermined by the analysis component 128 and stored in memory 120 as processed data 124. In other implementations, the information that is included in GUI 500 can be determined by the analysis component 128 on the fly in response to user input selecting the particular evaluation criteria and/or KPI (e.g., which is in this example, procedures by case quantity). As can be seen easily via this pie chart, the majority of the orthopedics cases are of procedure type 00106. In accordance with some implementations, the pie chart shown in GUI 500 is also selectable.

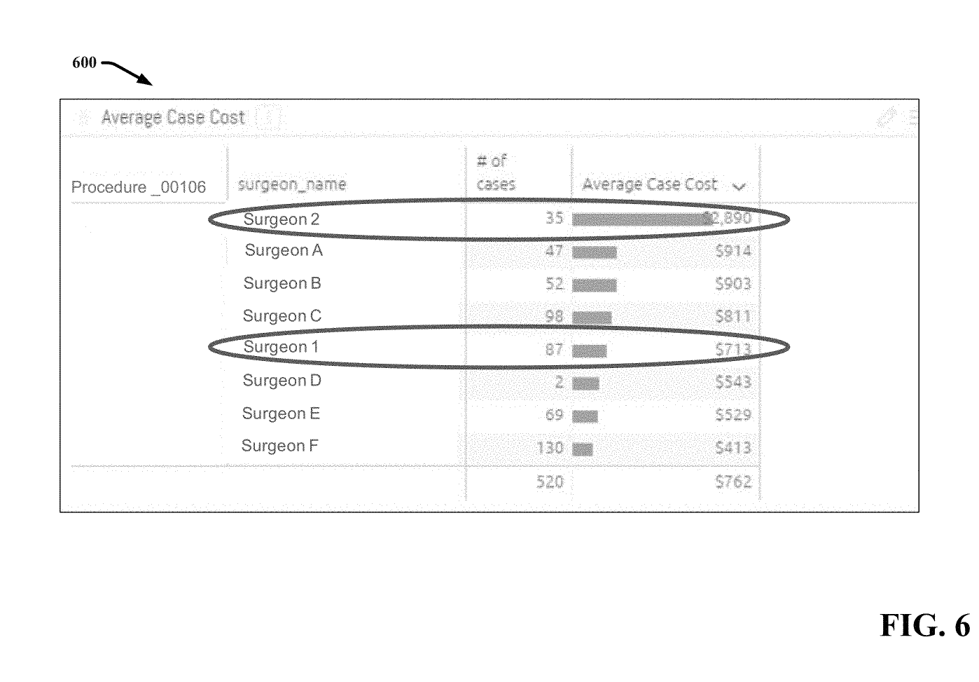

FIG. 6 presents an example GUI 600 including a table providing information regarding average case costs for different surgeons that performed the same procedure, which in this implementation is procedure 00106. The table identifies the different surgeons by name (e.g., arbitrarily represented as surgeon 2, surgeon A, surgeon B and so on), the number of cases performed by each surgeon, and the average case cost. In one embodiment, GUI 600 was generated in response to reception of user input selecting the procedure 00106 from GUI 500 for deeper evaluation. In the embodiment shown, surgeons 1 and 2 are circled or highlighted. In one aspect, the analysis component 128 can determine that surgeons 1 and 2 are strong candidates for comparing with respect to procedure costs differences based on information regarding defined variances thresholds between different costs. The analysis component 128 can further direct the procedure evaluation component 304 to highlight these to surgeons or otherwise recommend these to surgeons for comparison analysis. For example, Surgeon 2 is clearly associated with much higher case costs than the other surgeons. Surgeon 1 is associated with average or median case costs. Accordingly, comparison of surgeon 1 and 2 can uncover what aspects of the workflow followed by surgeon 2 are out of the norm. In another implementation, the user can chose to select surgeons 1 and 2 for further comparison analysis. For example, the in some implementations, the table shown in GUI 600 is also interactive and selectable.

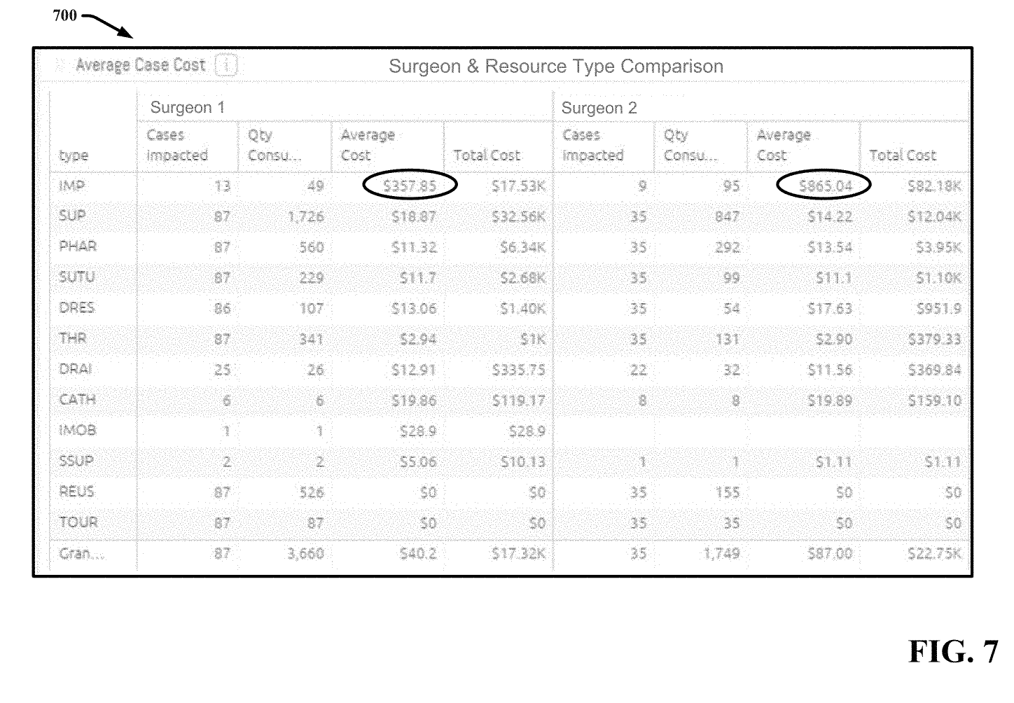

FIG. 7 presents an example GUI 700 including a table providing information regarding surgeon and resource type utilization comparison. In the embodiment shown, the selected surgeons 1 and 2 are being compared. The table identifies different types of resources on the far left (e.g., IMP, SUP, PHAR, SUTU, etc.) and for each surgeon, the table identifies the number of cases impacted for each resource type, the quantity of items consumed for each resource type, the average case cost attributed to each resource type, and the total costs attributed to resources utilization in each resource type for all cases performed by the respective surgeons. In some implementations, the procedure evaluation component 304 can be configured to direct the interface component 134 to generate GUI in response to selection of surgeons 1 and 2 from GUI 600. The information included in the table can be preprocessed by the analysis component 128 or determined on the fly based on the user input/selection. In the embodiment shown, the resource types are sorted in ascending order from highest cost to lowest cost. The resource IMP (corresponding to implants) is associated with the highest costs. As identified by the circled values for the respective surgeons, the average case costs for implant usage by surgeon 2 is more than double that of surgeon 1. In some implementations, the analysis component 128 can be configured to determine and direct the interface component to highlight or otherwise indicate one or more particular resource types associated with substantial variances (e.g., with respect to the other resource types and/or defined variance thresholds) for deeper investigation by the user.

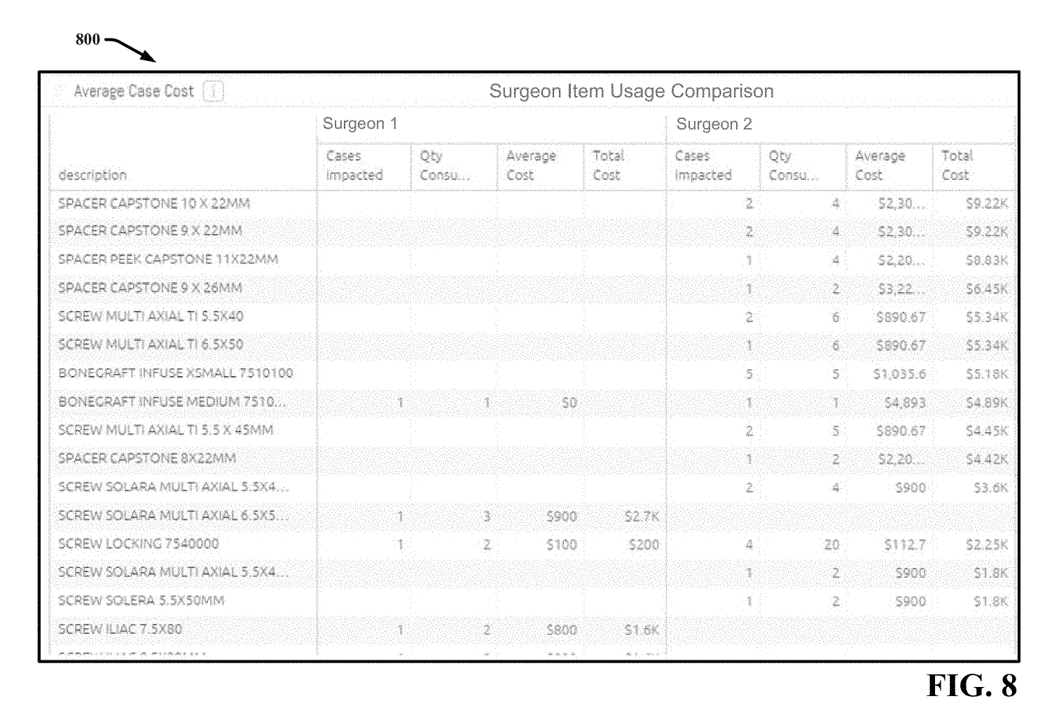

FIG. 8 presents an example GUI 800 including a table providing information regarding surgeon and item comparison with respect to a specific resource type, which in this example is IMP (or implants). In one implementation, the GUI 800 was generated and presented to the user in response to selection of the resource type IMP from the GUI 700 for deeper investigation. The table identifies different items on the far left (e.g., spacer capstone 10×22 mm, spacer capstone 9×22 mm, etc.) and for each surgeon and item, the table identifies the number of cases impacted, the quantity consumed, the average cost, and the total cost. As can be seen by this table, surgeon 2 seems to use (or potentially not use, but just order as directed by his DPC for this procedure), a large amount of unnecessary items for this procedure that results in substantial added costs.

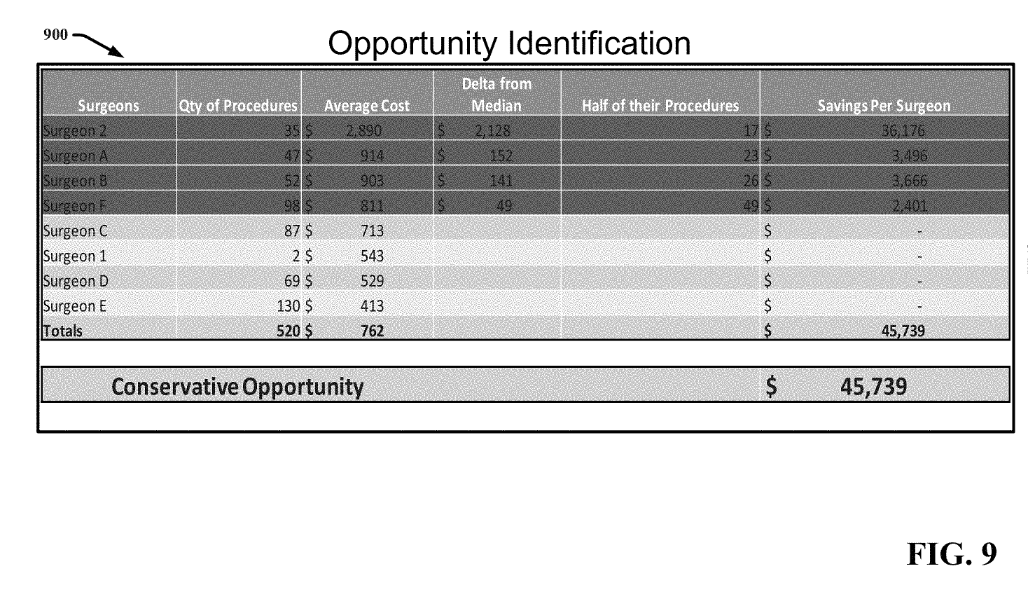

FIG. 9 presents an example GUI 900 including a table providing information regarding cost savings opportunity for a particular procedure. For example, the particular procedure can include the procedure selected and for investigation by the user, (e.g., procedure 00106). In the embodiment shown, the table identifies a set of surgeons that have performed the procedure and further identifies (e.g., as highlighted), a subset of surgeons that are associated with substantially higher costs relative to the other surgeons. For example, the substantially higher costs can be reflected in the delta from the median. For each surgeon, the table identifies the quantity of procedures performed and the average cost per case. For the higher costing surgeons, the table further identifies the delta from the median, half of their procedures and the potential amount of savings per surgeon that could be achieved if each of the surgeons were to adapt their workflows (e.g., with respect to at least resource utilization), to conform to the norm workflow followed by surgeon 1 for example. The total amount of savings is quite substantial at $45, 789.

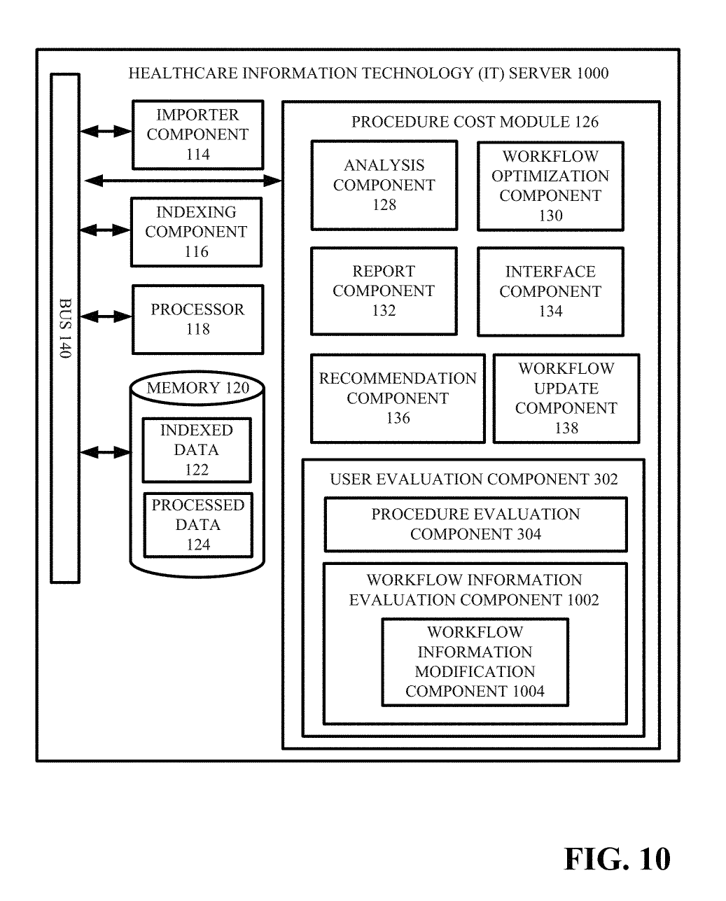

Turning now to FIG. 10, presented is another example healthcare IT server 1000 that facilitates evaluating and optimizing costs associated with medical procedures in accordance with various aspects and embodiments described herein. The healthcare IT server 1000 can include same or similar features and functionalities as healthcare IT server 300 with the addition of the workflow information evaluation component 1002 to the user evaluation component 302. Repetitive description of like elements employed in respective embodiments is omitted for sake of brevity.

In some embodiments, in addition to providing actionable insights regarding procedural changes that can be made to improve costs, the user evaluation component 302 can include workflow information evaluation component 1002 to facilitate examining workflow information for respective procedures and clinicians and implementing these changes in future workflows. In particular, the workflow information evaluation component 1002 can provide an interactive application that allows users to view the workflow information 108 that defines how a particular medical procedure should be performed. For example, for a particular procedure and/or clinician, the workflow information 108 can define resources to be used for the procedure, how they are to be used and when, where materials should be stored, procedural steps to be performed, how the procedural steps are to be performed, and the like. In some implementations, the workflow information 108 can control how a particular clinician is authorized to perform a particular procedure, including what medical supplies, instruments, equipment, etc. the clinician is authorized to order and use, what procedural steps to perform and timing for performance of the respective steps, restrictions on staff utilization, room/space utilization and the like. For example, in some embodiments, the workflow information 108 can include DPCs for various clinicians that control what materials are ordered for performance of a procedure by the clinician, when they are ordered, where there are stored, how they are utilized during the procedure and when, parameters or procedural steps to be followed during the procedure, other resource utilization requirements/preferences for performance of the procedure (e.g., regarding staffing, time, room/space utilization, etc.), and any other potential defined procedural components that can be controlled and have an impact on cost.

In addition to facilitating viewing the workflow information 108, the workflow information application can further provide for making changes to the workflow information that optimize costs. In this regard, the workflow information evaluation component 1002 can include workflow information modification component 1004 to provide one or more workflow information modification functions that allow users to apply changes to the workflow information. For example, the workflow information modification component 1004 can allow users to change parameters regarding resources to be utilized and ordered for a particular procedure and/or clinician. In this regard, the workflow information modification component 1004 can allow a user to select a particular resource such as a medical supply item and change the quantity of the item to be ordered or otherwise allocated for use for a particular procedure and/or clinician, remove the item from the list, add a new supply to the list, change a location where the supply is stored, change a parameter regarding what the supply can be used for or how the supply can be used, and the like. The updated workflow information can further be integrated into the clinical environment to control future workflows. In this regard, the workflow information modification component 1004 can allow a user to make changes to a DPC and then cause the DPC as stored by and/or utilized by the one or more healthcare information sources/systems 102 to control the corresponding workflow to be updated to reflect the changes. As a result, when the procedure is performed in the future by a particular clinician associated with the DPC, the materials that are ordered and other resources utilized, the processes performed and/or any other potential workflow components that are followed in association with performance of the procedure will be based on the updated DPC.

In some embodiments, the particular workflow information for evaluating and/or updating and the particular changes to be made can be determined and recommended by the recommendation component 136. In this regard, as discussed supra, the analysis component 128 and/or the workflow optimization component 130 can determine and provide recommendations regarding components of a particular procedure that can be changed to improve costs and how to change them. For example, the recommendation can identify one or more procedures, one or more clinicians, and/or one or more procedural components (e.g., resources) associated with workflow information recommended for updating and the particular manner in which the workflow information should be updated. For instance, in one implementation, the recommendation can identify a subset of clinicians that perform a particular procedure using an expensive instrument and recommend the workflow information for the respective clinicians to be updated to replace the expensive instrument with a cheaper alternative. In another example, the recommendation component can identify a particular type of resource rarely used in a subset of different procedures yet ordered in surplus and recommend the workflow information for the respective procedures to be updated to reduce the quantity of the resource used. In one embodiment, based on the recommended changes, the user can request to either accept or reject the changes. By accepting the changes, the workflow update component 138 can be configured to automatically update the corresponding workflow information 108 to reflect the changes.

In one implementation, the recommendation presented to a user can be provided in a GUI that includes a workflow update widget that allows the user to automatically apply the recommended changes to the corresponding workflow data files. In this regard, selection of the workflow update widget can cause the workflow update component 138 to effectuate the changes in the corresponding workflow data files as included in the workflow information 108 at the one or more healthcare information sources/systems 102.

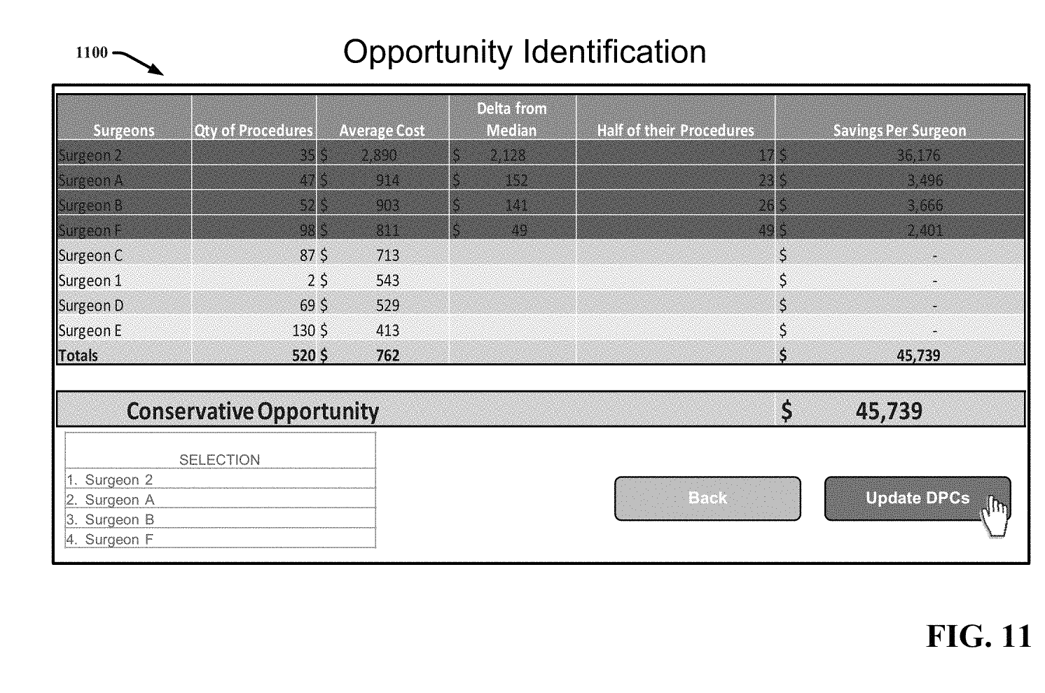

For example, FIG. 11 provides another GUI 1100 including a table providing information regarding cost savings opportunity for a particular procedure. The GUI can is substantially similar to GUI 900 with the addition of the workflow update functionality. In this regard, via the use can select one or more of the recommended surgeons for applying changes to their DPCs to optimize cost. In the embodiment shown, surgeons 2, A, B and F are selected. In one implementation, selection of the respective surgeons and the “Update DPCs” icon in the lower right hand corner of the GUI can cause the workflow update component 138 to automatically apply the changes to the DPCs for the respective clinicians. In another implementation, selection of the “Update DPCs” icon can result in the generation of a new GUI that allows the user to view and update the DPCs for the selected clinicians.

With reference back to FIG. 10, in another implementation, in association with reception of a recommendation regarding updating workflow information associated with one or more procedures and/or clinicians, the workflow information evaluation component 1002 can allow the user to access the corresponding workflow information and update the workflow information accordingly. For example, the recommendation can include a link to the workflow information for the associated with the recommendation. With these implementations, selection of the link can result in opening of the workflow information evaluation application and allow the user to make the changes via the workflow information modification function of the application.

In other embodiments, the particular workflow data files to change and the particular changes to make can be determined based in part on information presented to a user in one or more reports generated by the report component 132 and/or usage of the procedure evaluation application provided by the procedure evaluation component 304. In this regard, based on the information presented to a user in one or more reports generated by the report component 132 and/or in one or more dashboards generated in association with usage of the procedure evaluation application, the user can provide input selecting subsets of procedures, clinicians, procedural components and the like for evaluating using the workflow information evaluation component 1002. Based on selection of a subset of procedures, clinicians, procedural components and the like in association with a request to evaluate the corresponding workflow information, the workflow information evaluation component 1002 can open the workflow information evaluation application and present the user with the corresponding workflow information for evaluating and updating using the features and functionalities of the workflow information evaluation application.

For example, in some embodiments as discussed supra, the report component 132 can generate and present a user with information reporting determinations made by the analysis component 128 and/or the workflow optimization component 130 regarding procedure costs based on different KPIs. For instance, the analysis component 128 can determine information regarding one or more KPI reflective of procedure costs which can be presented to a user via a GUI generated by the interface component 134 in the form of one or more reports (e.g., including a visualization such as a table, a chart, a graph or the like. For example, the one or more reports can include information identifying relatively high cost procedures, relatively high cost surgeons, relatively high cost procedural components and the like. In another example, the one or more reports can include information relating different procedure costs by volume, procedure costs by service, procedure costs by clinician, clinician average costs by resource type, inventory procedure cost by resource type and the like. In another example, the one or more reports can include information regarding resource utilizations, such as amounts of different resource types and/or specific resource items used by different clinicians. The analysis component 128 can also determine subsets of procedures and/or clinicians associated with substantial variances in costs and further determine procedural components associated with one or more of the procedures and/or the clinicians in the subsets for which the variances are based. This information can also be included in a report that is presented to a user. Further, the workflow optimization component 130 can determine recommended changes to the one or more procedural components and these changes can be identified in the report.

In other embodiments, the procedure evaluation component 304 can facilitate generating information, visualizations, reports, etc. (such as those described above) based in part on user input. For example, as exemplified with reference to FIGS. 4-9, the procedure evaluation component 304 can allow a user to view information identifying procedure costs aggregated by service type, different procedure costs associated with a same service type, costs associated with different clinicians that performed a same procedure, and the like.

In some embodiments, the reports and/or dashboard visualizations can include interactive functionality and allow a user to select subsets of information included in the reports/dashboard visualizations, such as subsets of high cost procedures, subsets of high cost clinicians, subsets of high cost procedural components and the like. For example, with reference to FIG. 5, in one implementation, the user can select a particular procedure high cost from the pie chart (e.g., procedure 00106) for evaluating the DPCs for all clinicians that perform the procedure. In this regard, based on reception of input selecting the particular 00106 in association with a request to evaluate the corresponding workflow information, the workflow information evaluation component 1002 can open the workflow information evaluation application and present the user with the corresponding DPCs for all clinicians that perform the procedure 00106. In another example, report generated by the report component 132 and/or a dashboard presented to a user in association with usage of the procedure evaluation application can include a pivot table identifying percentages of items used by different clinicians in association with performance of a particular procedure (or group of procedures). For example, the pivot table can color code the different items based on the respective percentages used (e.g., green displays for items used 80% of the time or more, yellow displays for items used 80-60%, and red displays for items used 59% and below). Based on user input selecting one or more of the different items, this data can then retrieved and employed by the workflow information evaluation component 1002 to facilitate evaluating and potentially changing the corresponding workflow information.

The workflow information evaluation component 1002 can also provide tools that allow a user to select subsets of procedures, clinicians, and/or procedural components for evaluating the corresponding workflow information directly via the workflow information evaluation application. For example, using the workflow information evaluation application, the user can provide input selecting one or more procedures, one or more clinicians, one or more workflow components (e.g., a resource, a process, etc.) and the like. Based on the user input, the workflow information evaluation component 1002 can retrieve and present the user with corresponding workflow information. In some embodiments, the workflow information evaluation component 1002 can also allow the user to filter the workflow information based on one or more defined criteria. For example, the user can choose to filter (and/or the workflow information evaluation component 1002 can be configured to automatically filter), workflow information for different clinicians based on a minimum number of cases performed. For example, with respect to a single procedure, the DPCs for clinicians who have a very low volume of cases for that procedure can be excluded.

Thus in various embodiments, the recommendation component 136 can provide recommendations regarding workflow changes that can be applied to reduce cost (e.g., as determined by the analysis component 128 and/or the workflow optimization component 130), and/or the user can determine the workflow changes based on evaluation facilitated by the procedure evaluation component 304. Based on insight regarding what changes can be made to one or more components of a procedure workflow employed by one or more clinicians, the workflow information evaluation component 1002 can allow a user to modify DPC to reflect to account for the changes. Accordingly, the procedure cost module 126 can determine or facilitate determining what items are used by the majority of clinicians and then drive updates back into the workflow data files contained employed by one or more healthcare information sources/systems 102 used in controlling material utilization and ordering. For example, using the workflow information evaluation application provided by the workflow information evaluation component 1002, a user may investigate items that do not display as being used as often as they believe they are. This may illuminate a potential issue with inadequate documentation. The workflow information evaluation component 1002 also provides tools for investigating discrepancies where one clinician may use an expensive item while another uses a much less expensive item for the same purpose.

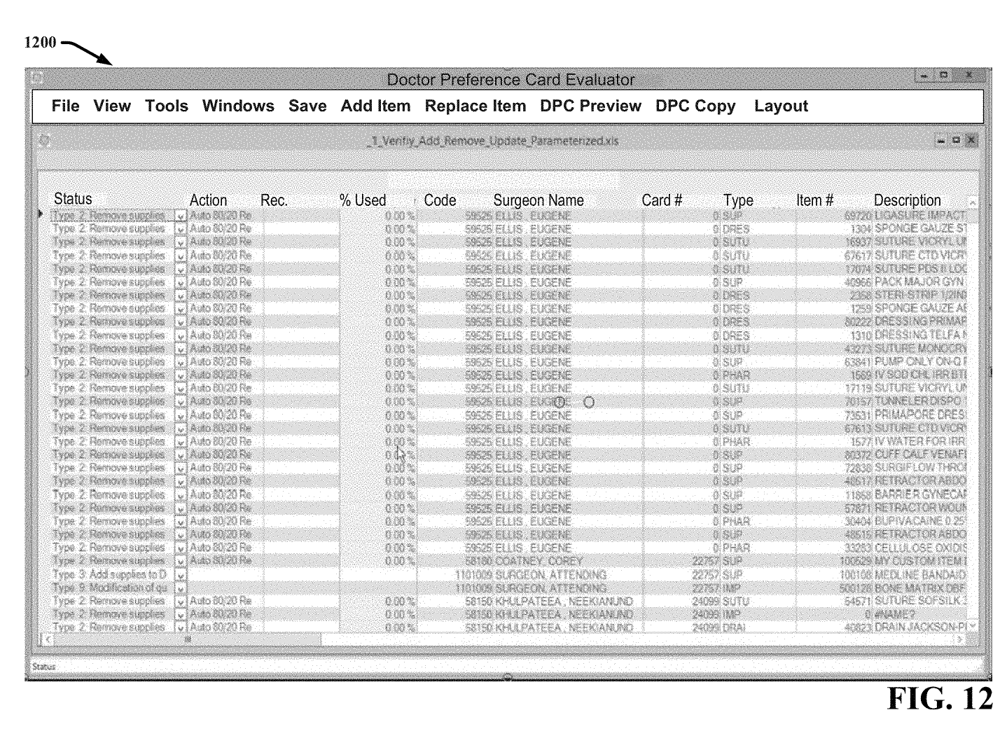

Various features and functionalities of the workflow information evaluation component 1002 and the workflow information modification component 1004 are further exemplified with reference to FIGS. 12-17. In particular, FIGS. 12-17 provide example graphical user interfaces and visualizations provided by a workflow information evaluation application (e.g., the workflow information evaluation component 1002) that facilitates evaluating and optimizing costs associated with medical procedures in accordance with various aspects and embodiments described herein. Repetitive description of like elements employed in respective embodiment is omitted for sake of brevity.

With reference to FIG. 12, presented is an example GUI 1200 generated in association with usage of a workflow information evaluation application provided by the workflow information evaluation component 1002. The GUI includes an upper menu bar providing various selectable menu items corresponding to one or more features and functionalities of the application. For example, in the embodiment shown, the upper menu bar includes a “file” option to view files, a “view” option to change the appearance or view of the chart presented below, “a windows” option to view information in different windows, and a “save” option to save changes made to files and DPCs. The upper menu bare also includes an “add item” option that allows a user to add an item to a DPC card, a “replace item” option that allows a user to replace an item on a DPC card, a “DC preview” option that allows a user to preview changes made to a DPC card, a “DPC copy” option that allows the user to copy a DPC card (e.g., to use as a template for another clinician), and a “layout” option that allows the user to change the layout of the display.

The GUI 1200 further includes a chart displaying information regarding a subset of DPCs associated with a particular procedure. In one implementation, the information included in the chart is based on user input selecting the criteria/parameters for retrieving a subset of DPCs in association with usage of the procedure evaluation application provided by the procedure evaluation component 304 and/or in association with information included in a report presented to the user. In another implementation, the user can have selected the DPC criteria from a corresponding selection functionality provided by the workflow information evaluation application directly. Still in other implementations, the particular DPC information included in the chart can be based on a recommendation provided by the recommendation component (e.g., identifying a particular procedure and/or subset of clinicians for evaluating the corresponding workflow information).

In some embodiments, GUI 1200 and the information included in the chart corresponds to a single file generated and presented to a user in association with a request to view DPC information for a selected subset. For example, in accordance with this embodiment, the selected subset could include a subset of surgeons that performed a same procedure, a subset of resource types used in the procedure, or a subset of items used in the procedure. The view of the chart shown in GUI 1200 merely presents a portion of the file information. The user can scroll down through the chart to view all the information included in the file. The information included in the chart is arranged in several column fields, respectively identified as “Status”, “Action”, Recommendation” “% used”, procedure “Code”, “Surgeon name”, “Card #,” resource “Type”, “Item #”, and item “Description.” It should be appreciated that one or more of the columns can be removed or rearranged using standard spreadsheet software functionalities. Each item is displayed in a row with the usage percentage.

The “Status” column identifies a particular status of the item, such as a particular change planned for this card. In some implementations, the status can be changed in association selection of a different status from a drop down list. In accordance with the embodiment shown, the status “Type 2: remove supplies” corresponds to removal of the supplies from the card. In one implementation, the workflow information evaluation component 1002 can apply a rule such that if usage is less than 80% the recommendation component 136 automatically populates the Status column to remove the item from the DPC. In addition to the status “Type 2: remove supplies”, other possible status option that can be selected which have corresponding functionalities include the following: “Type 1: Keep (No DPC Changes)”, “Type 3: Add supplies to DPC,” “Type 9: Modification of quantity (Use type 10 for 0 hold items),” “Type 10: 0 qty on Card (hold Items)”, and “Type 11: Replace Item with different Item”. Based on selection of a particular status and associated action, if a user subsequently request to apply the change, the workflow update component 138 can be configured to execute the change and update the DPC according.

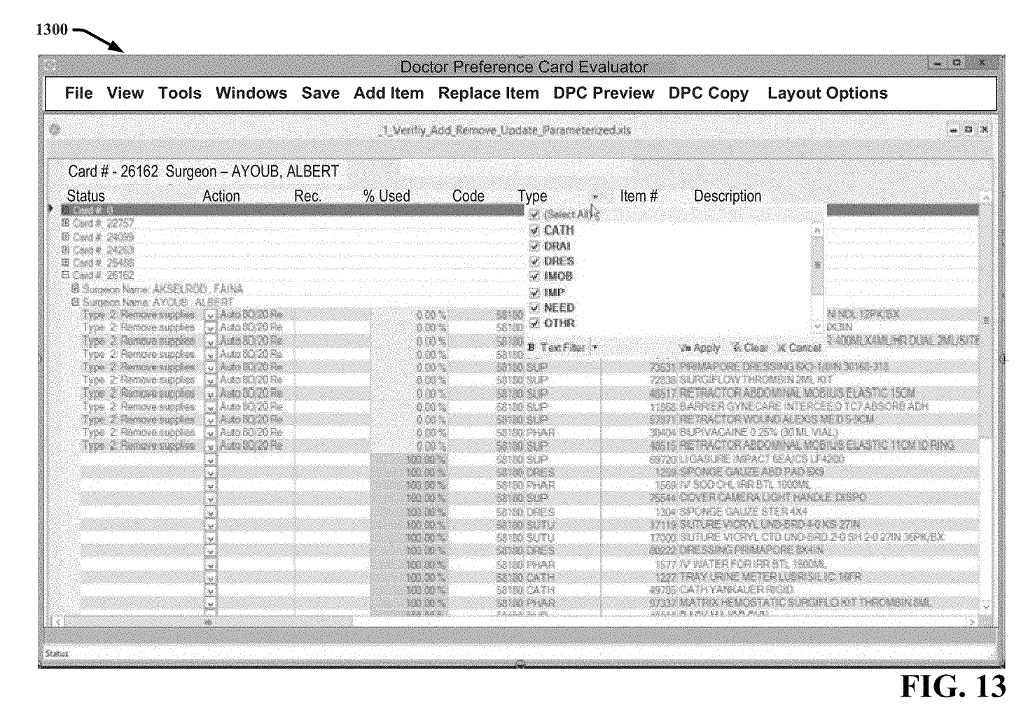

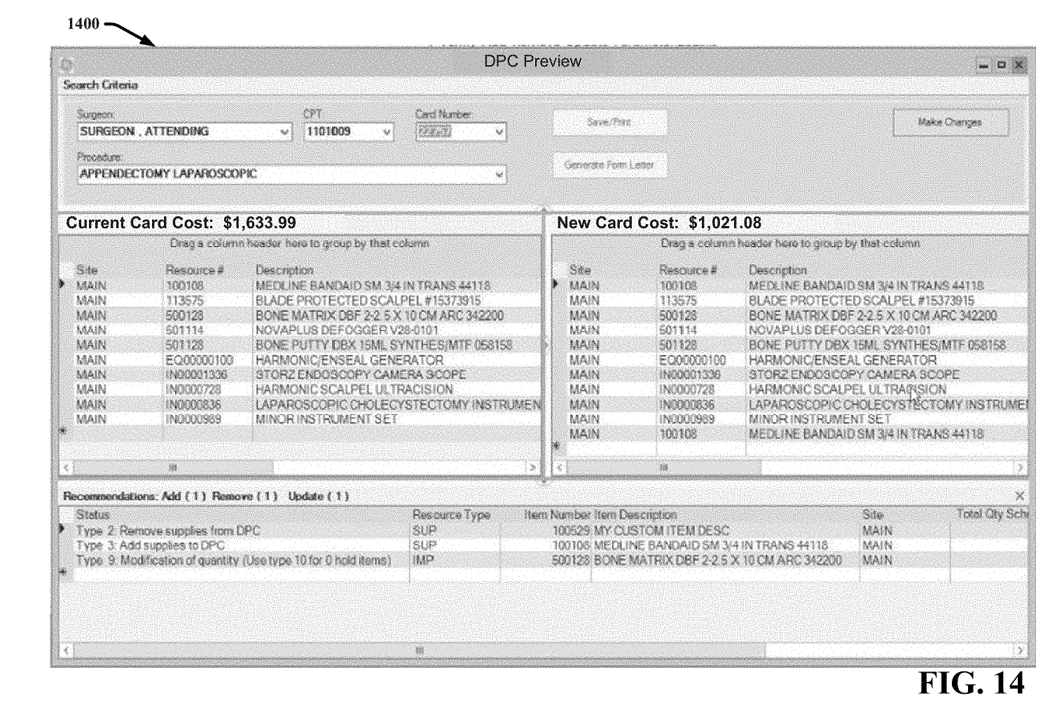

FIG. 13 presents an example GUI 1300 generated in association with selection of a particular card number and surgeon from the chart. For example, in the embodiment shown, card #26162 and surgeon AYOUB, ALBERT has been selected. In this regard, the user can filter the results to include a subset of resource types. For example, the columns can be sorted, filtered and grouped using common spreadsheet functions. In the example shown the user has chosen to group the cards by card number and Surgeon Name. In one implementation, to group, the user can left click and drag a column header above the other column headers. In this example, the user has also selected the resource “type” column which is associated with a dropdown menu that provides for selecting one or more different types of resources to include in the chart. These grouped, sorted and filtered layouts may also be saved using the Layout option button in the tool bar.

From the display shown in FIG. 13, the user can review this file and disposition each of the supplies using the dropdown in the Status column as noted above. The user would then scroll right to access the Recommendation column. It is noted that the various columns may be dragged and moved around in the file for ease of viewing based on the user's preferences. In the Recommendation column, the user can select (e.g., from a drop down menu) either Accepted or Not Accepted. In this regard, no action is taken on any item until the recommendation is documented. Once the user has applied desired changes to an items' status and provided a corresponding recommendation, the next step is to preview the updated DPC and make the change to the change to the DPC.

FIG. 14 presents an example GUI 1400 including a preview of an updated DPC card that was updated using the functionality of the previous GUI 1300. In some embodiments, GUI 1400 can be generated and presented to the user in response to selection of the DPC Preview button in the tool bar. The DPC preview GUI 1400 provides information regarding the particular surgeon, procedure and DPC card number that is being updated. The DPC preview can also provide a side by side comparison of the current DPC card and the new DPC card that would result upon application of the changes. The particular changes being made are called out in the recommendation section in the lower portion of the GUI. The preview also provides information identifying the change in cost associated with the current card and the new card. If the user determines all is as expected and approves the new card, the user can then select the “Make Changes” icon in the upper right corner. Selection of the “Make Changes” icon can result in the change to the card being automatically applied to the DPC (e.g., by the workflow update component 138) as stored in the workflow information 108.

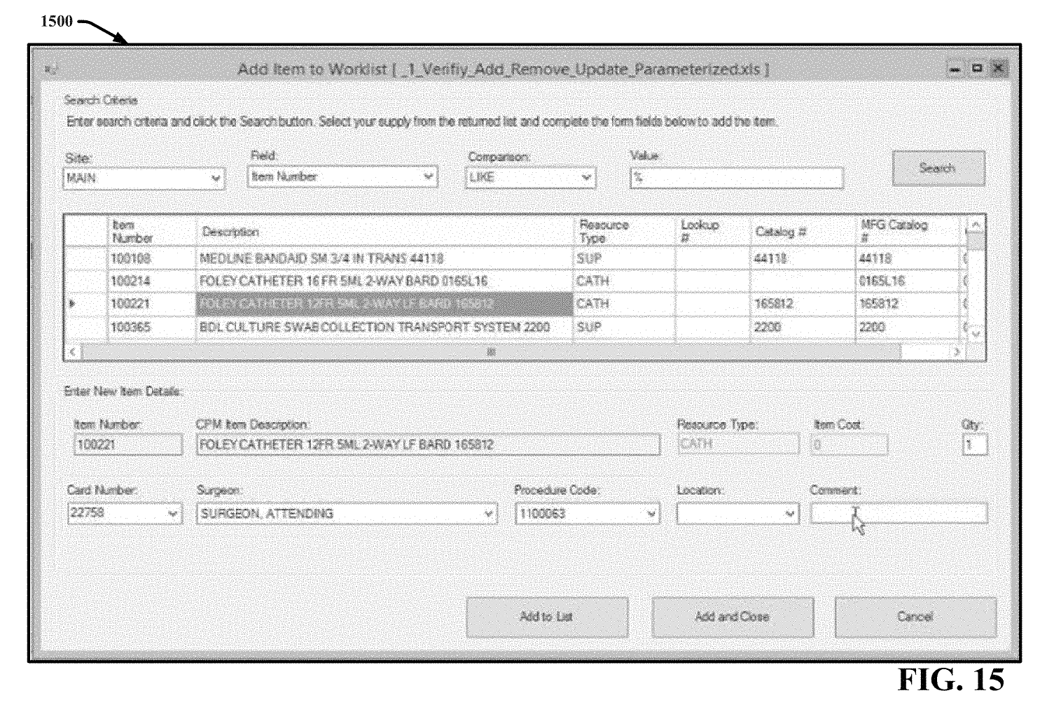

FIG. 15 presents an example GUI 1500 that facilitate adding items to a workflow data file (e.g., a DPC) using the add item functionality of the workflow information evaluation application. At the top of the GUI 1500 there is provided a search tool that allows the user to search for defined workflow components/items using several parameters. For example, in the embodiment shown, these parameters include item site, field, comparison, and value. In this example, the use has searched for and selected a particular supply, item number 100221. Once a particular item/component is selected, below the query results is presented are fields that allow the user to select a card number, surgeon, procedure code, and/or location where the item is to be added. There is also a field for comments. The user can then choose to add the item to the list, add and close, or cancel, using the command widgets at the bottom of the GUI 1500.

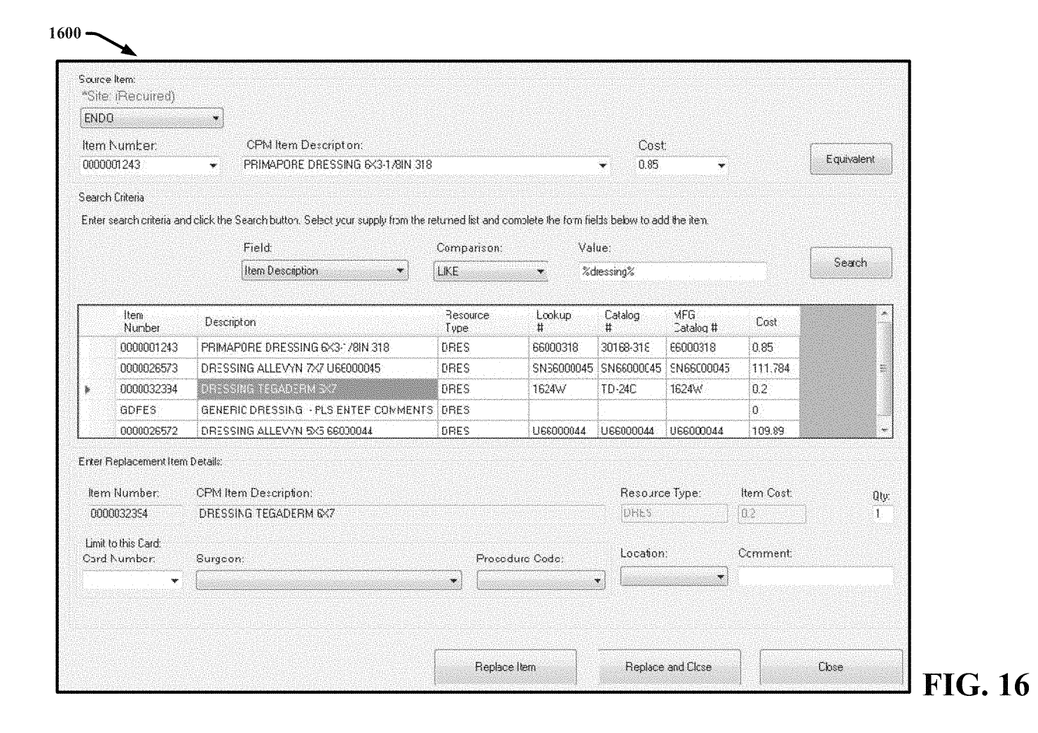

FIG. 16 presents an example GUI 1600 that facilitates replacing items to a workflow data file (e.g., a DPC) using the replace item functionality of the workflow information evaluation application. At the top of the GUI, there is a Site field that allows the use to select a site of the source item, the item that is to be replaced. In the embodiment shown, the source item has been automatically is populated into the fields below (e.g., item number 0000001243, PRIMAPORE DRESSING). If the user would like to replace the item with an equivalent resource, the user can select the “Equivalent” menu item to retrieve a list of equivalent items to replace this item with. If not, then the user can search for a desired replacement item using the search criteria functionality. The user can further selected a desired item to replace the source item from the list below the search query fields. Once a particular item/component is selected, the user can further select a card number, surgeon, procedure code, and/or location where the item is to be replaced. There is also a field for comments. The user can then choose to replace the item to the list, replace and close, or cancel/close, using the command widgets at the bottom of the GUI 1600.

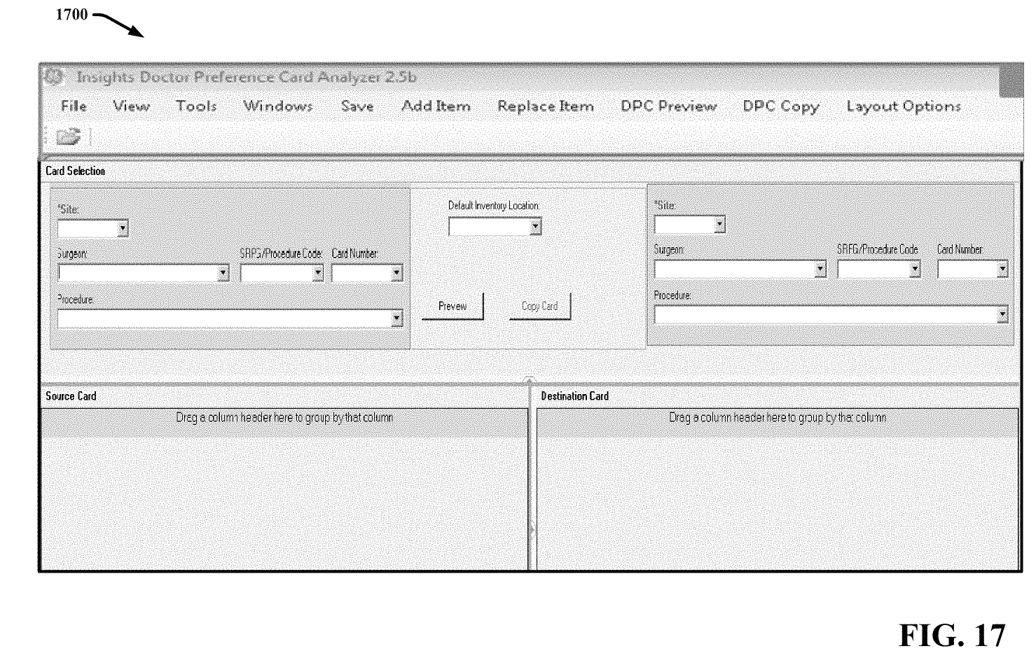

FIG. 17 presents an example GUI 1700 that facilitates replacing items to a workflow data file (e.g., a DPC) using the copy item functionality of the workflow information evaluation application. The copy item functionally can be employed for example to create a new DPC card for a particular clinician/procedure using an existing DPC card as a template. In the embodiment shown the GUI 1700 generated in response to selection of the “Copy Item” from the toolbar allows the user to choose the site and source card at the top left, the destination on the top right and the Default Inventory Location in the top center. This allows the user to copy a card with a default inventory location. The card can be copied to the same site or a different site. The cards will display under Source Card and Destination card. The new card number will be displayed on the destination card window. Once a new card has been selected and displayed in the destination card window, the user can select the preview icon to preview the new card and further select a request to copy the card from the preview GUI (not shown) if the user approves the new card.

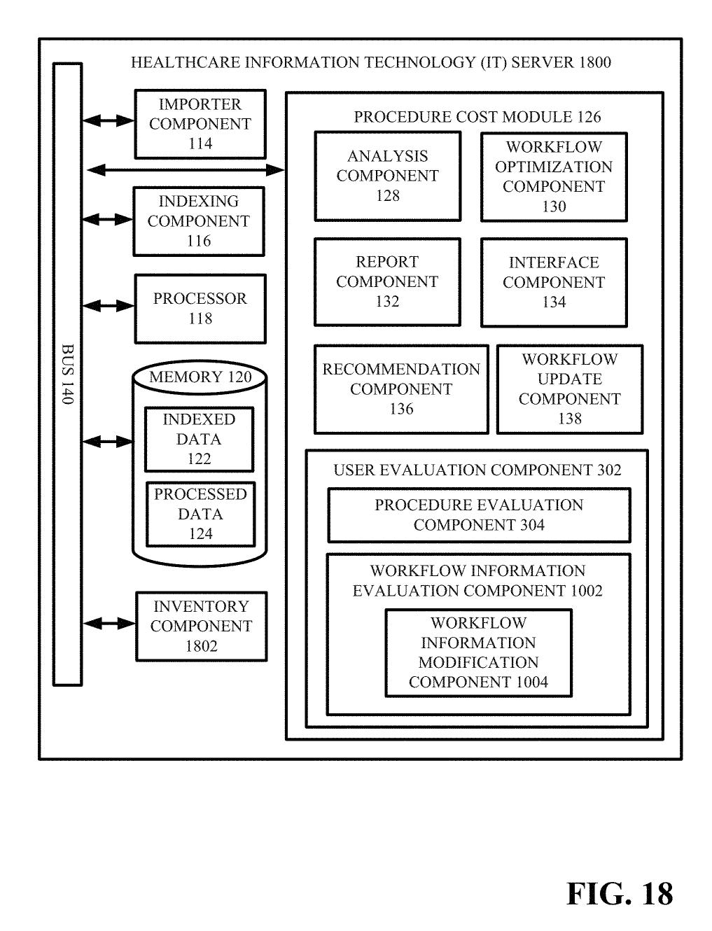

FIG. 18 provides another example healthcare IT server 1800 that facilitates evaluating and optimizing costs associated with medical procedures in accordance with various aspects and embodiments described herein. Healthcare IT server 1800 can include same or similar features and functionality as healthcare IT server 1000 with the addition of inventory component 1802. Repetitive description of like elements employed in respective embodiment is omitted for sake of brevity.

In various embodiments, the workflow update component 138 and/or the workflow information modification component 1004 can make updates or facilitate making updates to workflow data files (e.g., DPS) regarding medical materials (e.g., supplies, instruments, equipment, etc.) used for a procedure and/or by a particular clinician for the procedure. Thus the workflow data files can control what medical materials can be used for different procedures, who can use them, how they can be used, and the like. In some embodiments, the workflow data files can also control automatic ordering of medical material from suppliers. According to these embodiments, the healthcare IT server 1800 can include inventory component 1802 to facilitate automatic ordering of the appropriate medical supplies based on the information included in the workflow data files.

For example, in some implementations the inventory component 1802 can be configured to authorize or deny order requests for medical materials submitted by clinicians, healthcare personnel, or another authorized representative of a healthcare organization for which the materials are requested for based on whether the materials are included in a workflow data file for a particular procedure. In another implementation, the inventory component 1802 can control not only what medical supplies are ordered, but when they are ordered and the amount of materials that are ordered. For example, the inventory component 1802 can be configured to monitor the inventory information 110 that tracks information regarding medical supplies that are in stock or otherwise available for usage. Based on the inventory information 110 and scheduling information regarding what procedures are scheduled to be performed or expected amounts of the procedures to be performed within a defined time period (e.g., over the next month for example), and workflow information defining what materials are needed for the respective procedures, the inventory information can determine what materials need to be ordered and the quantities of materials needed. The inventory component 1802 can further interface with the suppliers purchasing systems and automatically place orders for the medical materials on behalf of the healthcare organization to which the materials will be provided.

The inventory component 1802 can also control where ordered medical materials are distributed within a healthcare organization. In this regard, the inventory component 1802 can ensure medical supplies that are needed for a particular procedure or subset of procedures that are performed at a particular location in a healthcare facility are delivered to the appropriate location. For example, the inventory component 1802 can ensure that materials defined in workflow data files for usage in association with cardiology based procedures are ordered and for delivered to the cardiology department. In another example, based on scheduling information indicating a surgery is scheduled for a particular surgeon on a certain date/time and in a specific operating room and workflow information for the surgery that indicates a specific supply is needed to be located in the scheduled operating room, the inventory component 1802 can control ordering and delivery of the supply to ensure that it located in the operating room at the time of surgery.

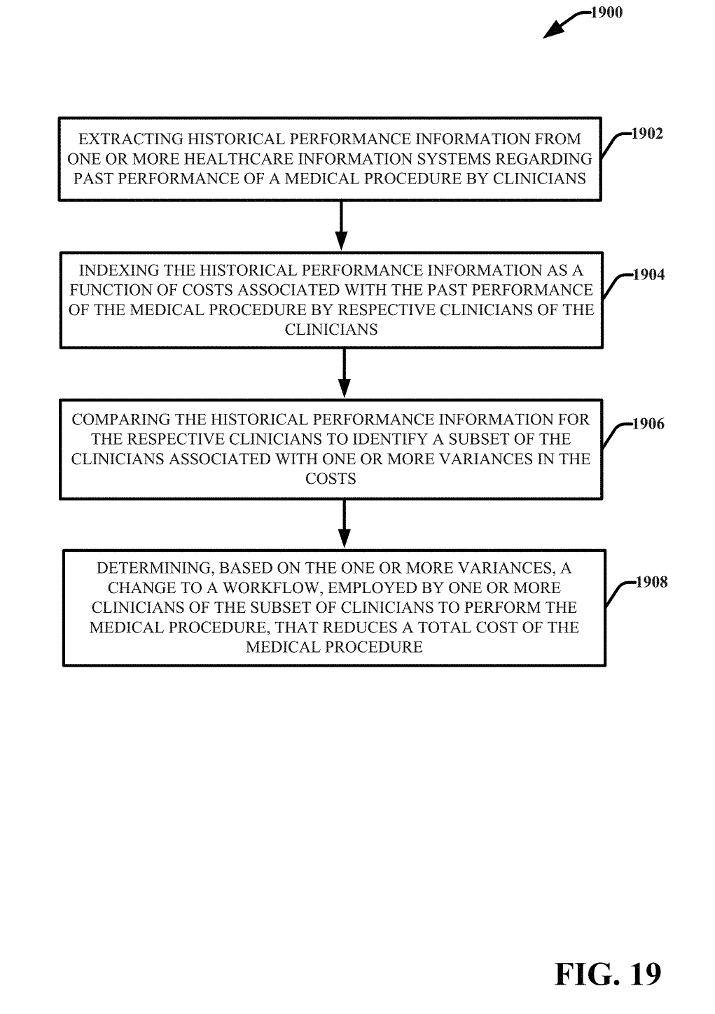

In view of the example systems and/or devices described herein, example methods that can be implemented in accordance with the disclosed subject matter can be further appreciated with reference to flowcharts in FIGS. 19-21. For purposes of simplicity of explanation, example methods disclosed herein are presented and described as a series of acts; however, it is to be understood and appreciated that the disclosed subject matter is not limited by the order of acts, as some acts may occur in different orders and/or concurrently with other acts from that shown and described herein. For example, a method disclosed herein could alternatively be represented as a series of interrelated states or events, such as in a state diagram. Moreover, interaction diagram(s) may represent methods in accordance with the disclosed subject matter when disparate entities enact disparate portions of the methods. Furthermore, not all illustrated acts may be required to implement a method in accordance with the subject specification. It should be further appreciated that the methods disclosed throughout the subject specification are capable of being stored on an article of manufacture to facilitate transporting and transferring such methods to computers for execution by a processor or for storage in a memory.

FIG. 19 illustrates a flow chart of an example method 1900 for evaluating and optimizing costs associated with medical procedures in accordance with various aspects and embodiments described herein. Repetitive description of like elements employed in respective embodiments is omitted for sake of brevity.

In one or more embodiments, method 1900 can be performed by a system comprising a processor (e.g., system 100) to execute the following computer executable instructions stored in a memory (e.g., memory 120) to perform acts 1902-1908. At 1902, the system can extract historical performance information from one or more healthcare information systems regarding past performance of a medical procedure by clinicians (e.g., via importer compone 114). At 1904, the system can index the historical performance information as a function of costs associated with the past performance of the medical procedure by respective clinicians of the clinicians (e.g., using indexing component 116). At 1906, the system can compare the historical performance information for the respective clinicians to identify a subset of the clinicians associated with one or more variances in the costs (e.g., using analysis component 128). At 1908, the system can further determine, based on the one or more variances, a change to a workflow, employed by one or more clinicians of the subset of clinicians to perform the medical procedure that reduces a total cost of the medical procedure (e.g., via workflow optimization component 130).

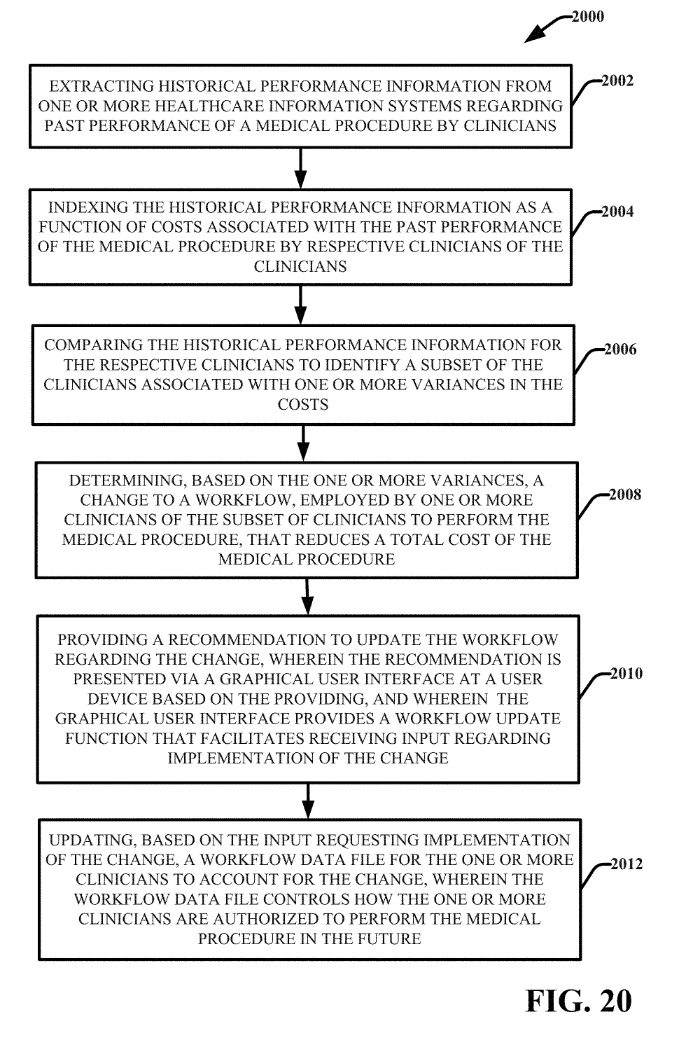

FIG. 20 illustrates a flow chart of an example method 2000 for evaluating and optimizing costs associated with medical procedures in accordance with various aspects and embodiments described herein. Repetitive description of like elements employed in respective embodiments is omitted for sake of brevity.

In one or more embodiments, method 2000 can be performed by a system comprising a processor (e.g., system 100) to execute the following computer executable instructions stored in a memory (e.g., memory 120) to perform acts 2002-2012. At 2002, the system can extract historical performance information from one or more healthcare information systems regarding past performance of a medical procedure by clinicians (e.g., via importer compone 114). At 2004, the system can index the historical performance information as a function of costs associated with the past performance of the medical procedure by respective clinicians of the clinicians (e.g., using indexing component 116). At 2006, the system can compare the historical performance information for the respective clinicians to identify a subset of the clinicians associated with one or more variances in the costs (e.g., using analysis component 128). At 2008, the system can further determine, based on the one or more variances, a change to a workflow, employed by one or more clinicians of the subset of clinicians to perform the medical procedure that reduces a total cost of the medical procedure (e.g., via workflow optimization component 130).

At 2010, the system can provide a recommendation (e.g., via recommendation component 136) to update the workflow regarding the change, wherein the recommendation is presented via a graphical user interface at a user device based on the providing, and wherein the graphical user interface provides a workflow update function that facilitates receiving input regarding implementation of the change, and wherein the method further comprises. At 2012, the system can update, based on the input requesting implementation of the change, a workflow data file for the one or more clinicians to account for the change (e.g., using workflow update component 138), wherein the workflow data file controls how the one or more clinicians are authorized to perform the medical procedure in the future.

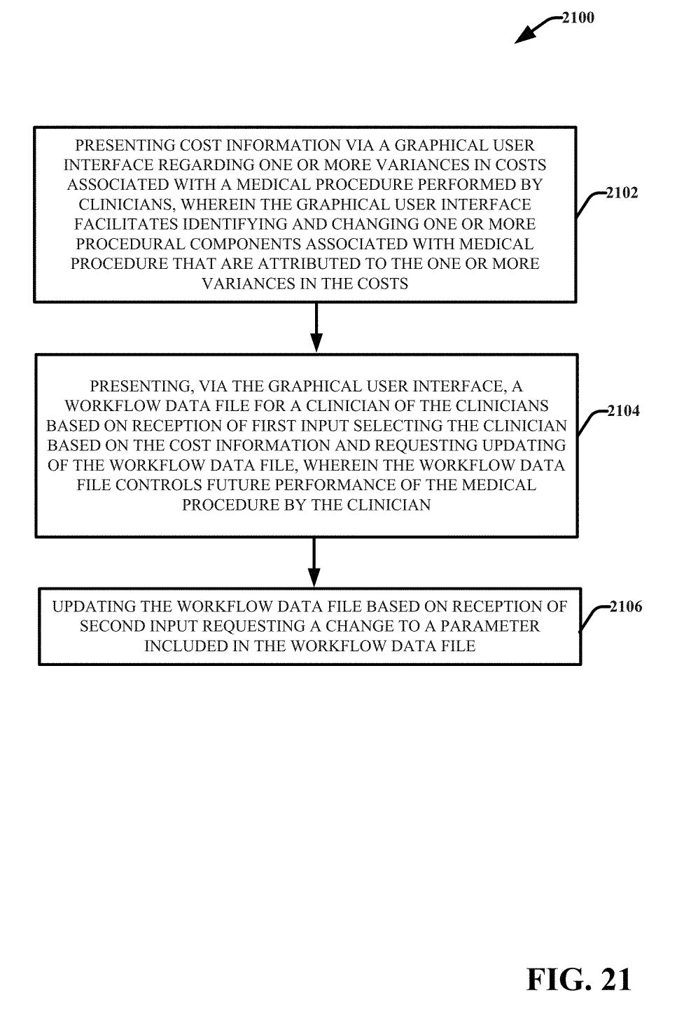

FIG. 21 illustrates a flow chart of an example method 2100 for evaluating and optimizing costs associated with medical procedures in accordance with various aspects and embodiments described herein. Repetitive description of like elements employed in respective embodiments is omitted for sake of brevity.

In one or more embodiments, method 2100 can be performed by a system comprising a processor (e.g., system 100) to execute the following computer executable instructions stored in a memory (e.g., memory 120) to perform acts 2102-206. At 2102, the system can present cost information via a graphical user interface regarding one or more variances in costs associated with a medical procedure performed by clinicians (e.g., using report component 132, interface component 134 and/or user evaluation component 302), wherein the graphical user interface facilitates identifying and changing one or more procedural components associated with medical procedure that are attributed to the one or more variances in the costs. At 2104, the system can present, via the graphical user interface, a workflow data file for a clinician of the clinicians based on reception of first input selecting the clinician based on the cost information and requesting updating of the workflow data file (e.g., using interface component 134 and workflow information evaluation component 1002), wherein the workflow data file controls future performance of the medical procedure by the clinician. At 2106, the system can update the workflow data file based on reception of second input requesting a change to a parameter included in the workflow data file (e.g., using the workflow information modification component 1004 and/or the workflow update component 138). In some implementations, the second input requests a change to a medical supply used for the medial procedure and wherein the workflow data file further controls automated ordering, by an inventory system (or component, such as inventory component 1802), of the medical supply for the future performance of the medical procedure by the clinician.

### Example Operating Environments

The systems and processes described below can be embodied within hardware, such as a single integrated circuit (IC) chip, multiple ICs, an application specific integrated circuit (ASIC), or the like. Further, the order in which some or all of the process blocks appear in each process should not be deemed limiting. Rather, it should be understood that some of the process blocks can be executed in a variety of orders, not all of which may be explicitly illustrated in this disclosure.

With reference to FIG. 22, a suitable environment 2200 for implementing various aspects of the claimed subject matter includes a computer 2202. The computer 2202 includes a processing unit 2204, a system memory 2206, a codec 2205, and a system bus 2208. The system bus 2208 couples system components including, but not limited to, the system memory 2206 to the processing unit 2204. The processing unit 2204 can be any of various available processors. Dual microprocessors and other multiprocessor architectures also can be employed as the processing unit 2204.

The system bus 2208 can be any of several types of bus structure(s) including the memory bus or memory controller, a peripheral bus or external bus, and/or a local bus using any variety of available bus architectures including, but not limited to, Industrial Standard Architecture (ISA), Micro-Channel Architecture (MSA), Extended ISA (EISA), Intelligent Drive Electronics (IDE), VESA Local Bus (VLB), Peripheral Component Interconnect (PCI), Card Bus, Universal Serial Bus (USB), Advanced Graphics Port (AGP), Personal Computer Memory Card International Association bus (PCMCIA), Firewire (IEEE 13224), and Small Computer Systems Interface (SCSI).

The system memory 2206 includes volatile memory 2210 and non-volatile memory 2212. The basic input/output system (BIOS), containing the basic routines to transfer information between elements within the computer 2202, such as during start-up, is stored in non-volatile memory 2212. In addition, according to present innovations, codec 2205 may include at least one of an encoder or decoder, wherein the at least one of an encoder or decoder may consist of hardware, a combination of hardware and software, or software. Although, codec 2205 is depicted as a separate component, codec 2205 may be contained within non-volatile memory 2212. By way of illustration, and not limitation, non-volatile memory 2212 can include read only memory (ROM), programmable ROM (PROM), electrically programmable ROM (EPROM), electrically erasable programmable ROM (EEPROM), or flash memory. Volatile memory 2210 includes random access memory (RAM), which acts as external cache memory. According to present aspects, the volatile memory may store the write operation retry logic (not shown in FIG. 22) and the like. By way of illustration and not limitation, RAM is available in many forms such as static RAM (SRAM), dynamic RAM (DRAM), synchronous DRAM (SDRAM), double data rate SDRAM (DDR SDRAM), and enhanced SDRAM (ESDRAM.

Computer 2202 may also include removable/non-removable, volatile/non-volatile computer storage medium. FIG. 22 illustrates, for example, disk storage 2214. Disk storage 2214 includes, but is not limited to, devices like a magnetic disk drive, solid state disk (SSD) floppy disk drive, tape drive, Jaz drive, Zip drive, LS-70 drive, flash memory card, or memory stick. In addition, disk storage 2214 can include storage medium separately or in combination with other storage medium including, but not limited to, an optical disk drive such as a compact disk ROM device (CD-ROM), CD recordable drive (CD-R Drive), CD rewritable drive (CD-RW Drive) or a digital versatile disk ROM drive (DVD-ROM). To facilitate connection of the disk storage 2214 to the system bus 2208, a removable or non-removable interface is typically used, such as interface 2216.

It is to be appreciated that FIG. 22 describes software that acts as an intermediary between users and the basic computer resources described in the suitable operating environment 2200. Such software includes an operating system 2218. Operating system 2218, which can be stored on disk storage 2214, acts to control and allocate resources of the computer 2202. Applications 2220 take advantage of the management of resources by operating system 2218 through program modules 2224, and program data 2226, such as the boot/shutdown transaction table and the like, stored either in system memory 2206 or on disk storage 2214. It is to be appreciated that the claimed subject matter can be implemented with various operating systems or combinations of operating systems.

A user enters commands or information into the computer 2202 through input device(s) 2228. Input devices 2228 include, but are not limited to, a pointing device such as a mouse, trackball, stylus, touch pad, keyboard, microphone, joystick, game pad, satellite dish, scanner, TV tuner card, digital camera, digital video camera, web camera, and the like. These and other input devices connect to the processing unit 2204 through the system bus 2208 via interface port(s) 2230. Interface port(s) 2230 include, for example, a serial port, a parallel port, a game port, and a universal serial bus (USB). Output device(s) 2236 use some of the same type of ports as input device(s). Thus, for example, a USB port may be used to provide input to computer 2202, and to output information from computer 2202 to an output device 2236. Output adapter 2234 is provided to illustrate that there are some output devices 2236 like monitors, speakers, and printers, among other output devices 2236, which require special adapters. The output adapters 2234 include, by way of illustration and not limitation, video and sound cards that provide a means of connection between the output device 2236 and the system bus 2208. It should be noted that other devices and/or systems of devices provide both input and output capabilities such as remote computer(s) 2238.

Computer 2202 can operate in a networked environment using logical connections to one or more remote computers, such as remote computer(s) 2238. The remote computer(s) 2238 can be a personal computer, a server, a router, a network PC, a workstation, a microprocessor based appliance, a peer device, a smart phone, a tablet, or other network node, and typically includes many of the elements described relative to computer 2202. For purposes of brevity, only a memory storage device 2240 is illustrated with remote computer(s) 2238. Remote computer(s) 2238 is logically connected to computer 2202 through a network interface 2242 and then connected via communication connection(s) 2244. Network interface 2242 encompasses wire and/or wireless communication networks such as local-area networks (LAN) and wide-area networks (WAN) and cellular networks. LAN technologies include Fiber Distributed Data Interface (FDDI), Copper Distributed Data Interface (CDDI), Ethernet, Token Ring and the like. WAN technologies include, but are not limited to, point-to-point links, circuit switching networks like Integrated Services Digital Networks (ISDN) and variations thereon, packet switching networks, and Digital Subscriber Lines (DSL).

Communication connection(s) 2244 refers to the hardware/software employed to connect the network interface 2242 to the bus 2208. While communication connection 2244 is shown for illustrative clarity inside computer 2202, it can also be external to computer 2202. The hardware/software necessary for connection to the network interface 2242 includes, for exemplary purposes only, internal and external technologies such as, modems including regular telephone grade modems, cable modems and DSL modems, ISDN adapters, and wired and wireless Ethernet cards, hubs, and routers.

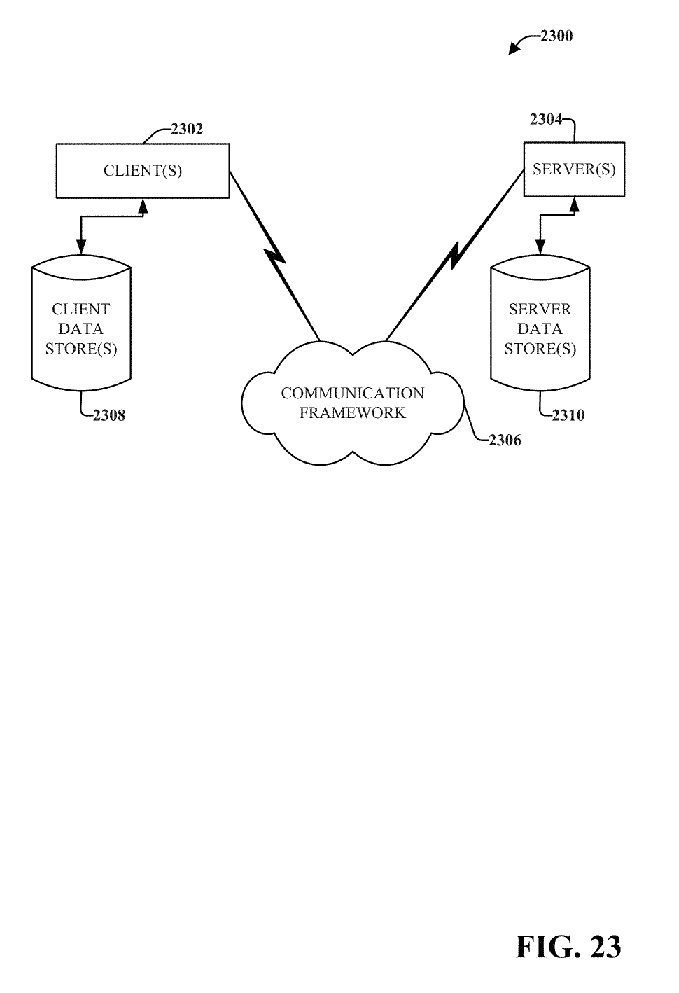

Referring now to FIG. 23, there is illustrated a schematic block diagram of a computing environment 2300 in accordance with this disclosure. The computing environment 2300 includes one or more client(s) 2302 (e.g., laptops, smart phones, PDAs, media players, computers, portable electronic devices, tablets, and the like). The client(s) 2302 can be hardware and/or software (e.g., threads, processes, computing devices). The computing environment 2300 also includes one or more server(s) 2304. The server(s) 2304 can also be hardware or hardware in combination with software (e.g., threads, processes, computing devices). The servers 2304 can house threads to perform transformations by employing aspects of this disclosure, for example. One possible communication between a client 2302 and a server 2304 can be in the form of a data packet transmitted between two or more computer processes wherein the data packet may include video data. The data packet can include a metadata, e.g., associated contextual information, for example. The computing environment 2300 includes a communication framework 2306 (e.g., a global communication network such as the Internet, or mobile network(s)) that can be employed to facilitate communications between the client(s) 2302 and the server(s) 2304.

Communications can be facilitated via a wired (including optical fiber) and/or wireless technology. The client(s) 2302 include or are operatively connected to one or more client data store(s) 2308 that can be employed to store information local to the client(s) 2302 (e.g., associated contextual information). Similarly, the server(s) 2304 are operatively include or are operatively connected to one or more server data store(s) 2310 that can be employed to store information local to the servers 2304.

In one embodiment, a client 2302 can transfer an encoded file, in accordance with the disclosed subject matter, to server 2304. Server 2304 can store the file, decode the file, or transmit the file to another client 2302. It is to be appreciated, that a client 2302 can also transfer uncompressed file to a server 2304 and server 2304 can compress the file in accordance with the disclosed subject matter. Likewise, server 2304 can encode video information and transmit the information via communication framework 2306 to one or more clients 2302.

The illustrated aspects of the disclosure may also be practiced in distributed computing environments where certain tasks are performed by remote processing devices that are linked through a communications network. In a distributed computing environment, program modules can be located in both local and remote memory storage devices.

Moreover, it is to be appreciated that various components described in this description can include electrical circuit(s) that can include components and circuitry elements of suitable value in order to implement the embodiments of the subject innovation(s). Furthermore, it can be appreciated that many of the various components can be implemented on one or more integrated circuit (IC) chips. For example, in one embodiment, a set of components can be implemented in a single IC chip. In other embodiments, one or more of respective components are fabricated or implemented on separate IC chips.

What has been described above includes examples of the embodiments of the present invention. It is, of course, not possible to describe every conceivable combination of components or methodologies for purposes of describing the claimed subject matter, but it is to be appreciated that many further combinations and permutations of the subject innovation are possible. Accordingly, the claimed subject matter is intended to embrace all such alterations, modifications, and variations that fall within the spirit and scope of the appended claims. Moreover, the above description of illustrated embodiments of the subject disclosure, including what is described in the Abstract, is not intended to be exhaustive or to limit the disclosed embodiments to the precise forms disclosed. While specific embodiments and examples are described in this disclosure for illustrative purposes, various modifications are possible that are considered within the scope of such embodiments and examples, as those skilled in the relevant art can recognize.

In particular and in regard to the various functions performed by the above described components, devices, circuits, systems and the like, the terms used to describe such components are intended to correspond, unless otherwise indicated, to any component which performs the specified function of the described component (e.g., a functional equivalent), even though not structurally equivalent to the disclosed structure, which performs the function in the disclosure illustrated exemplary aspects of the claimed subject matter. In this regard, it will also be recognized that the innovation includes a system as well as a computer-readable storage medium having computer-executable instructions for performing the acts and/or events of the various methods of the claimed subject matter.

The aforementioned systems/circuits/modules have been described with respect to interaction between several components/blocks. It can be appreciated that such systems/circuits and components/blocks can include those components or specified sub-components, some of the specified components or sub-components, and/or additional components, and according to various permutations and combinations of the foregoing. Sub-components can also be implemented as components communicatively coupled to other components rather than included within parent components (hierarchical). Additionally, it should be noted that one or more components may be combined into a single component providing aggregate functionality or divided into several separate sub-components, and any one or more middle layers, such as a management layer, may be provided to communicatively couple to such sub-components in order to provide integrated functionality. Any components described in this disclosure may also interact with one or more other components not specifically described in this disclosure but known by those of skill in the art.

In addition, while a particular feature of the subject innovation may have been disclosed with respect to only one of several implementations, such feature may be combined with one or more other features of the other implementations as may be desired and advantageous for any given or particular application. Furthermore, to the extent that the terms “includes,” “including,” “has,” “contains,” variants thereof, and other similar words are used in either the detailed description or the claims, these terms are intended to be inclusive in a manner similar to the term “comprising” as an open transition word without precluding any additional or other elements.

As used in this application, the terms “component,” “module,” “system,” or the like are generally intended to refer to a computer-related entity, either hardware (e.g., a circuit), a combination of hardware and software, software, or an entity related to an operational machine with one or more specific functionalities. For example, a component may be, but is not limited to being, a process running on a processor (e.g., digital signal processor), a processor, an object, an executable, a thread of execution, a program, and/or a computer. By way of illustration, both an application running on a controller and the controller can be a component. One or more components may reside within a process and/or thread of execution and a component may be localized on one computer and/or distributed between two or more computers. Further, a “device” can come in the form of specially designed hardware; generalized hardware made specialized by the execution of software thereon that enables the hardware to perform specific function; software stored on a computer readable storage medium; software transmitted on a computer readable transmission medium; or a combination thereof.

Moreover, the words “example” or “exemplary” are used in this disclosure to mean serving as an example, instance, or illustration. Any aspect or design described in this disclosure as “exemplary” is not necessarily to be construed as preferred or advantageous over other aspects or designs. Rather, use of the words “example” or “exemplary” is intended to present concepts in a concrete fashion. As used in this application, the term “or” is intended to mean an inclusive “or” rather than an exclusive “or”. That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form.

Computing devices typically include a variety of media, which can include computer-readable storage media and/or communications media, in which these two terms are used in this description differently from one another as follows. Computer-readable storage media can be any available storage media that can be accessed by the computer, is typically of a non-transitory nature, and can include both volatile and nonvolatile media, removable and non-removable media. By way of example, and not limitation, computer-readable storage media can be implemented in connection with any method or technology for storage of information such as computer-readable instructions, program modules, structured data, or unstructured data. Computer-readable storage media can include, but are not limited to, RAM, ROM, EEPROM, flash memory or other memory technology, CD-ROM, digital versatile disk (DVD) or other optical disk storage, magnetic cassettes, magnetic tape, magnetic disk storage or other magnetic storage devices, or other tangible and/or non-transitory media which can be used to store desired information. Computer-readable storage media can be accessed by one or more local or remote computing devices, e.g., via access requests, queries or other data retrieval protocols, for a variety of operations with respect to the information stored by the medium.

On the other hand, communications media typically embody computer-readable instructions, data structures, program modules or other structured or unstructured data in a data signal that can be transitory such as a modulated data signal, e.g., a carrier wave or other transport mechanism, and includes any information delivery or transport media. The term “modulated data signal” or signals refers to a signal that has one or more of its characteristics set or changed in such a manner as to encode information in one or more signals. By way of example, and not limitation, communication media include wired media, such as a wired network or direct-wired connection, and wireless media such as acoustic, RF, infrared and other wireless media.

In view of the exemplary systems described above, methodologies that may be implemented in accordance with the described subject matter will be better appreciated with reference to the flowcharts of the various figures. For simplicity of explanation, the methodologies are depicted and described as a series of acts. However, acts in accordance with this disclosure can occur in various orders and/or concurrently, and with other acts not presented and described in this disclosure. Furthermore, not all illustrated acts may be required to implement the methodologies in accordance with certain aspects of this disclosure. In addition, those skilled in the art will understand and appreciate that the methodologies could alternatively be represented as a series of interrelated states via a state diagram or events. Additionally, it should be appreciated that the methodologies disclosed in this disclosure are capable of being stored on an article of manufacture to facilitate transporting and transferring such methodologies to computing devices. The term article of manufacture, as used in this disclosure, is intended to encompass a computer program accessible from any computer-readable device or storage media.

What is claimed is:

1. A system for extraction and analysis of healthcare provider performance, comprising:
a memory that stores computer executable components; and
a processor that executes the computer executable components stored in the memory, wherein the computer executable components comprise:
an importer component that extracts historical performance information from one or more healthcare information systems regarding past performance of a medical procedure by clinicians;
an indexing component that indexes the historical performance information as a function of costs associated with the past performance of the medical procedure by respective clinicians of the clinicians;
an analysis component that compares the historical performance information for the respective clinicians to identify a subset of the clinicians associated with one or more variances in the costs; and
a workflow optimization component that facilitates determining, based on the one or more variances, a change to a workflow, employed by one or more clinicians of the subset of clinicians to perform the medical procedure, that reduces a total cost of the medical procedure.

2. The system of claim 1, wherein the computer executable components further comprise:
a workflow update component that updates a workflow data file for the one or more clinicians to account for the change, wherein the workflow data file controls how the one or more clinicians are authorized to perform the medical procedure in the future.

3. The system of claim 1, wherein the analysis component further compares the historical performance information for the subset of clinicians to determine one or more procedural components associated with the past performance of the medical procedure by the subset of the clinicians that are attributed to the one or more variances, and wherein the workflow optimization component further facilitates determining the change based on the one or more procedural components.

4. The system of claim 1, wherein the change comprises a modification to a medical supply employed for the medical procedure, and wherein the computer executable components further comprise:
a workflow update component that updates a workflow data file for the one or more clinicians to account for the change, wherein the workflow data file controls ordering of the medical supply for future performance of the medical procedure by the one or more clinicians.

5. The system of claim 4, wherein the computer executable components further comprise:
an inventory component that orders the medical supply for the future performance of the medical procedure based on the workflow data file.

6. The system of claim 1, wherein the computer executable components further comprise:
a recommendation component that provides a recommendation to update the workflow regarding the change; and
an interface component that provides a graphical user interface that presents the recommendation.

7. The system of claim 6, wherein the graphical user interface provides a workflow update function that facilitates receiving input regarding implementation of the change, and wherein the computer executable components further comprise:
a workflow update component that updates, based on the input requesting implementation of the change, a workflow data file for the one or more clinicians to account for the change, wherein the workflow data file controls how the one or more clinicians are authorized to perform the medical procedure in the future.

8. The system of claim 1, wherein the computer executable components further comprise:
an evaluation component that facilitates determining one or more procedural components associated with the past performance of the medical procedure by the subset of the clinicians that are attributed to the one or more variances in the costs.

9. The system of claim 8, wherein the one or more procedural components comprise medical supplies used in association with performance of the medical procedure, and wherein the analysis component determines usage information regarding usage amounts of the medical supplies by respective clinicians of the subset of clinicians.

10. The system of claim 9, wherein the computer executable components further comprise:
an interface component that presents the usage information via a graphical user interface and provides a workflow update function, wherein the workflow update function facilitates selecting a supply of the medical supplies as included in a workflow data file for a clinician of the subset of clinicians, and changing a parameter associated with the medical supply based on the usage information.

11. The system of claim 10, wherein the computer executable components further comprise:
a workflow update component that updates, based on received input changing the parameter, the workflow data file to reflect the parameter as changed, wherein the workflow data file controls usage of the medical supply for future performance of the medical procedure by the clinician.

12. The system of claim 2, wherein the analysis component employs one or more machine learning algorithms to determine the one or more procedural components.

13. The system of claim 1, wherein the workflow optimization component employs one or more machine learning algorithms to determine the change.

14. A method comprising:
using a processor to execute the following computer executable instructions stored in a memory to perform the following acts:
extracting historical performance information from one or more healthcare information systems regarding past performance of a medical procedure by clinicians;
indexing the historical performance information as a function of costs associated with the past performance of the medical procedure by respective clinicians of the clinicians;
comparing the historical performance information for the respective clinicians to identify a subset of the clinicians associated with one or more variances in the costs; and
determining, based on the one or more variances, a change to a workflow, employed by one or more clinicians of the subset of clinicians to perform the medical procedure, that reduces a total cost of the medical procedure.

15. The method of claim 14, further comprising:
updating a workflow data file for the one or more clinicians to account for the change, wherein the workflow data file controls how the one or more clinicians are authorized to perform the medical procedure in the future.

16. The method of claim 14, further comprising:
comparing the historical performance information for the subset of clinicians to determine one or more procedural components associated with the past performance of the medical procedure by the subset of the clinicians that are attributed to the one or more variances, and further determining the change based on the one or more procedural components.

17. The method of claim 14, further comprising:
providing a recommendation to update the workflow regarding the change, wherein the recommendation is presented via a graphical user interface at a user device based on the providing.

18. The method of claim 17, wherein the graphical user interface provides a workflow update function that facilitates receiving input regarding implementation of the change, and wherein the method further comprises:
updating, based on the input requesting implementation of the change, a workflow data file for the one or more clinicians to account for the change, wherein the workflow data file controls how the one or more clinicians are authorized to perform the medical procedure in the future.

19. A tangible computer-readable storage medium comprising computer-readable instructions that, in response to execution, cause a computing system to perform operations, comprising:
presenting cost information via a graphical user interface regarding one or more variances in costs associated with a medical procedure performed by clinicians, wherein the graphical user interface facilitates identifying and changing one or more procedural components associated with medical procedure that are attributed to the one or more variances in the costs;
presenting, via the graphical user interface, a workflow data file for a clinician of the clinicians based on reception of first input selecting the clinician based on the cost information and requesting updating of the workflow data file, wherein the workflow data file controls future performance of the medical procedure by the clinician; and
updating the workflow data file based on reception of second input requesting a change to a parameter included in the workflow data file.

20. The tangible computer-readable storage medium of claim 19, wherein the change comprises a modification to a medical supply used for the medial procedure and wherein the workflow data file further controls automated ordering, by an inventory system, of the medical supply for the future performance of the medical procedure by the clinician.
